(19) United States
(12) Patent Application Publication
(10) Pub. No.: US 2026/0192970 A1
(43) Pub. Date: Jul. 9, 2026

(54) CUP, A BLANK FOR A CUP, AND A METHOD OF FORMING A CUP

(71) Applicant: Choose Planet A Limited, Hong Kong (CN)

(72) Inventor: Cyril Michel Drouet, Hong Kong (CN)

(21) Appl. No.: 19/554,480

(22) Filed: Mar. 2, 2026

Related U.S. Application Data
(63) Continuation-in-part of application No. 19/232,539, filed on Jun. 9, 2025, now Pat. No. 12,606,343.
Application No. 19/232,539 is a continuation of application No. 18/824,810, filed on Sep. 4, 2024, now Pat. No. 12,606,342.
Application No. 18/824,810 is a continuation of application No. 18/388,791, filed on Nov. 10, 2023, now Pat. No. 12,286,279.
Application No. 18/388,791 is a continuation of application No. 17/769,499, filed on Oct. 16, 2020, now abandoned.
(63) Continuation-in-part of application No. 19/130,807, filed on Nov. 17, 2023.

(30) Foreign Application Priority Data
Oct. 17, 2019 (CN) 19131129.9
Nov. 18, 2022 (GB) 2217290.2
Jun. 9, 2023 (GB) 2308658.0

(51) Int. Cl. B65D 5/02; B31B 50/73; B31B 100/00; B31B 120/10; B65D 5/12; B65D 5/40; B65D 5/72

(52) U.S. Cl. CPC B65D 5/0254; B31B 50/732; B65D 5/0209; B65D 5/12; B65D 5/40; B65D 5/72; B31B 2100/00; B31B 2120/10

(57) ABSTRACT

A cup includes a base. A wall extends from the base to a rim of the cup. A lid arrangement, including at least one closure flap extending from the rim that is foldable inwards about a fold line coincident with at least part of the rim, forms at least part of a lid of the cup. The rim includes a generally rectangular shape with at least one straight side and at least one arced side.

### RELATED APPLICATIONS

This application is a continuation-in-part of and claims priority to U.S. application Ser. No. 19/232,539, filed Jun. 9, 2025, which is a continuation of and claims priority to U.S. application Ser. No. 18/824,810, filed Sep. 4, 2024, which is a continuation of and claims priority to U.S. application Ser. No. 18/388,791, filed Nov. 10, 2023, now patented as U.S. Pat. No. 12,286,279, which is a continuation of and claims priority to U.S. application Ser. No. 17/769,499, filed Apr. 15, 2022, which claims priority to PCT Application No. PCT/CN2020/121419, filed Oct. 16, 2020, which claims priority to CN patent application Ser. No. 19/131,129.9, filed Oct. 17, 2019; this application is also a continuation-in-part of U.S. application Ser. No. 19/130,807, filed May 16, 2025, which claims priority to PCT Application No. PCT/EP2023/082221, filed Nov. 17, 2023, which claims priority to GB Application No. 2217290.2, filed on Nov. 18, 2022, and to GB Application No. 2308658.0, filed on Jun. 9, 2023; and the content of each of the above-listed related applications is incorporated herein by reference.

### TECHNICAL FIELD

This disclosure relates to a cup, and particularly, although not exclusively, to a cup with a closable lid.

### BACKGROUND

Disposable items are common in today's society. Disposable cups, such as paper cups or plastic cups, are commonly used today in the food and beverage industry. These disposable items are often discarded or recycled after a single or limited use.

Food and drink cups are often provided with a separate lid to render the cup spill-proof. These lids are often separate parts that are placed onto and secured to the cup after the cup is filled with liquid or solids, e.g., drinks or food. The lid may then be removed by a user to access the drink or food, after which the lid may then be discarded or recycled along with the cup.

These separable lids often have to be processed, e.g., recycled separate to the rest of the cup because they are made of a different material. In many instances, the lids are often made from plastic, which can be recycled but at greater costs compared with the cup.

Additionally, these removable lids can have some practical difficulties for the end user, as they can often be incorrectly positioned onto the cup and, in turn, cause the cup to leak. In use, end users may need to make extra effort to correctly attach the lid to the cup, such as by accurately aligning the lid with the upper edge of the cup whilst exerting an even force to ensure the lid is fitted to the edge of the cup. If the lid is not correctly positioned or misaligned, spillage can occur when a user is using the cup.

### BRIEF DESCRIPTION OF THE DRAWINGS

Notwithstanding any other forms which may fall within the scope of the present disclosure, one or more embodiments will now be described, by way of example only, with reference to the accompanying drawings in which:

FIG. 1 illustrates an example of a cup with a lid.

FIG. 2 illustrates an example of a blank of a cup that is used to create the cup shown in FIG. 1.

FIG. 3 illustrates the cup of FIG. 1 with the second closure flap in folded back position.

FIG. 4 illustrates a first fold formed within the first closure flap.

FIG. 5 illustrates a second fold formed within the second closure flap.

FIG. 6 illustrates the first closure flap in a closed position.

FIG. 7 illustrates the second closure flap being folded to a closed position.

FIG. 8 illustrates a force being applied to an upper surface of the second closure flap to engage the locking tab of the second closure flap into a locking opening.

FIG. 9 illustrates the locking tab engaged in a locking opening to lock the lid in a closed position.

FIG. 10 illustrates a force applied to an upper surface of the second closure flap to unlock the locking tab.

FIG. 11 illustrates the locking tab being disengaged from the locking opening.

FIG. 12 illustrates the outlet opening and cover in a closed position, covering the outlet opening.

FIG. 13 illustrates the cover in an open position such that the outlet opening is accessible and open.

FIG. 14 illustrates the longitudinal edges overlapping and attached to each other with a cut out in one longitudinal edge.

FIGS. 15 and 16 illustrate side views of the second closure flap moving to a folded back orientation.

FIGS. 17 and 18 illustrate front views of the second closure flap moving to a folded back orientation.

FIG. 19 shows an example of a cup with a lid arrangement in an open position.

FIG. 20 shows an example of a blank for forming a cup.

FIG. 21 shows an enlarged view of a section of the blank of FIG. 20.

FIGS. 22A-22F show different stages of closing a lid arrangement of a cup.

FIG. 23 shows an enlarged view of a section of a blank for forming a cup.

FIGS. 24A-24C show an exemplary blank for forming a cup.

FIG. 24D shows a top view of a cup with the lid arrangement in a closed embodiment.

FIGS. 25A-25B show an exemplary blank for forming a cup.

FIG. 25C shows a side view of a cup with the lid arrangement in a closed embodiment.

FIG. 26A shows an exemplary blank for forming a cup.

FIG. 26B shows an isometric view of a cup when a lid arrangement is in a closed position.

### DETAILED DESCRIPTION OF THE DRAWINGS

Cups, e.g., paper and plastic cups, are commonplace in modern society and are used to hold food and/or drink, i.e., hold solids and/or liquids. Cups are often disposable cups that are discarded to landfill or recycled. Commonly used cups often have separate lids that are attached to the cup to seal the cup. The lid can often include an opening to dispense the contents of the cup. The lids also have to be disposed to landfill or recycled. The lids are often made of plastic materials that are different from the cup. The lids can be challenging to use because the lid is required to be pushed onto the edge of the cup. This can be challenging, and the lid can often be incorrectly positioned onto the cup. Further, the lid has to be pushed onto the cup with an even force all around the lid in order to correctly secure the lid onto the cup. This can be challenging for people, resulting in a misplaced lid or crushing of lids.

The present disclosure relates to an improved cup. The present disclosure relates to a cup with a closable and an openable lid. The present disclosure relates to a cup with an integrated lid that is formed as part of the cup. The lid can be opened and closed easily by folding at least two flaps of the cup to define the lid in a closed position. The integrated lid makes it simpler to close the cup as compared to a separate lid that has to be pushed onto the cup. Further, the integrated lid may be reused along with the cup or may be recycled or disposed of with the cup. The integrated lid reduces the number of components and can help to reduce the overall waste produced since there is no separate lid to the cup.

The present disclosure relates to a cup, in particular, but not limited to a cup with a closable lid. The cup comprises an integrated lid, i.e., a lid that is not a separate piece. The lid is formed as part of the cup.

In an embodiment, the cup for retaining a liquid or a solid comprises; a base, a wall, the base and the wall defining a container with a space to retain the liquid, a first closure flap and a second closure flap, the first closure flap and second closure flap attached to the wall and extending from the wall, the first closure flap and the second closure flap being foldable relative to the wall, the first closure flap and second closure flap foldable between an open position and a closed position, wherein the first closure flap and the second closure flap defining a lid when in the closed position, and; the lid being defined by a first closure flap being folded at least twice to a closed position and the second closure flap being folded at least once to a closed position.

In an embodiment, the cup for retaining a liquid or a solid comprises: a base, a wall extending from the base, the wall is defining a cylinder or prism with a hollow space within to retain a liquid or solid, a lid, the lid comprising at least two closure flaps, wherein the lid is moved to a closed position by at least a three-fold arrangement, wherein the three fold arrangement comprises folding at least one closure flap once and folding the other flap at least twice. The flap that is folded twice may comprise at least two oblique fold features and a transverse fold feature. The flap is folded along the transverse fold feature first and then the oblique fold features.

In an embodiment, the cup for retaining a liquid or solid comprises: a base, a wall, the wall and the base defining a container including a hollow space to receive and retain the liquid or solid, a first closure flap and a second closure flap attached to and extending from the wall, the first closure flap and second closure flap being separate from each other (i.e., unconnected to each other), the first closure flap and second closure flap being foldable along fold features between an open position and a closed position, the first and second closure flaps defining a lid that is closed due to the first closure flap and the second closure flap being folded to a closed position, and the first closure flap comprising three edges, the three edges comprising two opposing arcuate edges and an intermediate edge extending between the two arcuate edges. The intermediate edge may comprise a curved edge. The arcuate edges each comprise two arcuate sections, each arcuate section comprising a different arc length. Further, the two arcuate sections comprise different radii. The two arcuate sections provide additional sealing lips when the first closure flap is folded. The first closure flap may be folded at least twice, and the second closure flap is folded at least once to move to a closed position and define a closed lid.

The cup is formed using a blank. The blank defines a wall, a first closure flap, and a second closure flap. The blank also comprises a plurality of fold features. The closure flaps can fold along the fold features to fold between an open position and a closed position. The first closure flap comprises at least two oblique fold features. The blank comprises a first transverse fold feature and a second transverse fold feature. The first closure flap is associated with the first transverse fold feature to allow the first closure flap to fold along the first transverse fold feature. The second closure flap is associated with the second fold feature to allow the second closure flap to fold along the second fold feature.

In a further form, a blank for a cup that is used to form a cup comprises: a wall, a first closure flap attached to the wall and extending from the wall, a second closure flop attached to the wall and extending from the wall, the first closure flap and second closure flap being integrally formed with the wall, the blank being a one piece construction, the first closure flap comprising a pair of opposed arcuate edges and an intermediate edge extending between the arcuate edges, the first closure flap comprising two oblique fold features, the first closure flap attached to the wall at a first transverse fold feature, the second closure flap attached to the wall at a second transverse fold feature, wherein in use, the first closure flap may be foldable first about at least the oblique fold features and foldable about the first transverse fold feature, the second closure flap foldable about the second transverse fold feature, and a lid being formed by the first closure flap being folded twice and the second closure flap being folded once. The blank comprises a third transverse fold feature disposed on the second closure flap, the second closure flap being foldable about the third transverse fold feature and/or the second transverse fold feature, and wherein the second transverse fold feature and the third transverse fold feature are curved. The third transverse fold feature and the second transverse fold feature comprise opposing curvatures.

Additionally, generally, also disclosed herein is a cup with one or more flaps extending from an upper rim and forming a closable (and openable) lid. The lid can be opened and closed by folding the flap(s) inward to define the lid in a closed position. The integrated lid makes it simpler to close the cup as compared to a separate lid that has to be pushed onto the cup. Further, the cup with an integrated lid may be reused or may be recycled as a single item. The integrated lid reduces the number of components required to be used by a food or beverage supplier, and can help to reduce the overall waste produced.

In an embodiment, a cup may include a spout arrangement. As the flap(s) are folded inward from an upright position, a portion of a flap remains upright. A spout may be formed that extends vertically from the rim of the cup. A spout aperture may be left in the lid (which is formed by the flap), through which liquid may flow from the cup out of the spout when the cup is tilted. An aperture enlargement portion may extend from the spout aperture. The aperture enlargement portion may be frangibly connected to the flap (and optionally include a foldable connection to the flap), such that it may be punched through. In other arrangements, the aperture enlargement portion may be formed by a cut line between the aperture enlargement portion and the flap, and may include a foldable connection to the flap, such that it is foldable inwards on application of an inward force. This enlarges the spout aperture to accommodate, for example, a straw.

In an embodiment, a cup may include a side seam, resulting from a blank being formed into a cup. The side seam is positioned to accommodate folding of the flap(s) when defining the closable lid. In particular arrangements, an upper rim of the cup forms a generally rectangular shape. The generally rectangular shape may be a rectangle with at least one arced side. The generally rectangular shape may be a rectangle with two arced sides and two straight sides. In such arrangements, the side seam may be positioned on a wall of the cup such that it extends downwards from a corner of the generally rectangularly shaped rim. This means that the seam does not need to extend into the flaps and so does not hinder the folding of the flaps to close the lid.

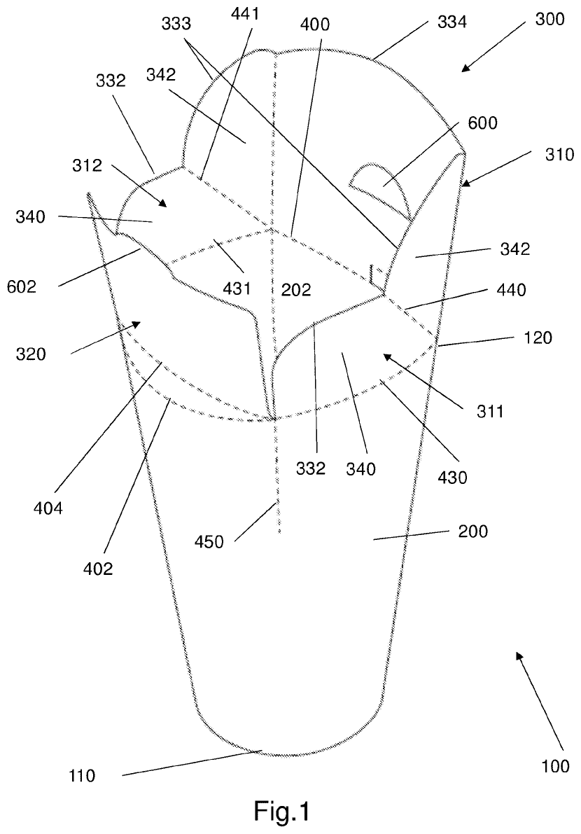

FIG. 1 illustrates an embodiment of a cup 100 for retaining a liquid or a solid within it. The cup 100 comprises a base 110 and a wall 200. The wall 200 may be attached to the base 110 and extends upward from the base 110. The wall 200 terminates in a top 120. In FIG. 1, the top 120 is shown as open. The wall 200 is shown as an upstanding wall. The wall 200 is a continuous wall and is in the shape of a cylinder or a prism, as shown in FIG. 1. The wall 200 defines a container with a space 202 therein. Liquids, solids, or other things can be placed into and retained within the container 202. The wall 200 bounds the space 202. In an embodiment, the base 110 may be integrated with the wall 200 (not shown from the bottom view). The base 110 may be formed by bending or folding a lower portion (not shown) of the wall to form a base. The lower portions that are folded or bent may be adhered together, welded, or attached by any other suitable manner to form the base.

Alternatively, the base 110 may be a separate piece (not shown) that is coupled to a lower region of the wall 200. In this alternative embodiment, the base 110 may be a separate disk-shaped piece (not shown) that is adhered to the lower portion, e.g., a lower edge of the wall, to form the base 110.

The cup 100 comprises a lid 300. The lid 300 is integrated with the wall 200 and positioned about the top 120. The lid 300 is connected to the wall 200. The lid 300 and the wall 200 may form a monolithic structure. The lid 300 is configured to move between an open position and a closed position. The lid 300 is folded to a closed position and unfolded to an open position. The integrated lid 300 is advantageous because the lid can be easily closed and opened, and a user can easily fold and unfold the lid. The user does not need to correctly align the lid with an upper edge of the cup and then apply an even force to secure the lid. Further, the integrated lid means the lid cannot be lost.

In an embodiment, the lid 300, the wall 200, and the base 110 may all be formed from the same material. For example, in one form, the cup 100 may be formed from paper or a paperboard. In another form, the cup 100 (i.e., the base 110, wall 200, and the lid 300) may be formed from cardboard. In a further form, the cup 100 (i.e., the base 110, wall 200 and the lid 300) may be formed from a natural fibre material, e.g., jute. In a further form, the cup 100 may be formed from a composite material comprising natural fibres and synthetic fibres. In a further form, the cup 100 may be formed from a plastics material or a polymer, e.g., a thermoplastic polymer. In a further form, the cup 100 may be formed from a recycled plastic material or a recyclable plastic material.

In an embodiment, the material of the cup 100 may be multi-ply paperboard with at least two overlapping fibrous layers. The multi-ply paperboard may comprise three or more plies. At least one ply, e.g., a middle ply may comprise a chemical pulp or a bleached chemical pulp or a bleached chemi-thermo mechanical pulp. The outer plies may be formed from a bleached pulp. The multi-ply paperboard may be coated with a suitable coating material to provide heat proofing or strength to the paperboard. For example, liquid barrier or beat proof materials may be added as a coating. Some examples of coatings can comprise a polymeric film or a biopolymer coating, a PE coating, a PP coating or a plant based coating which may be Further, advantageous as it is fully biodegradable. The material of the cup 100 may also include pigments to provide colour.

The cup may include graphics, logos or other indicia disposed on the cup. For example an outer surface of the wall 200 may comprise a logo or other indicia such that the logo and other indicia is visible to a user. An outer surface or outer face of the lid 300 may comprise a logo, graphics or other indicia that are visible to the user, e.g., when a user is drinking from the cup.

The cup 100 may be any suitable size. The cup 100 may be sized to have a volume of between 4 oz to 20 oz. The container, i.e., the space 202 may comprise a volume of between 4 oz to 20 oz. For example, the cup 100 may be sized to have a volume of the cup (i.e., the space 202) may be any one of 4 oz, 5 oz, 6 oz, 7 oz, 8 oz, 9 oz, 10 oz, 12 oz, 16 oz, 20 oz. Alternatively the cup 100 may sized and shaped to define any suitable volume. The cup 100 may comprise standard volume sizes.

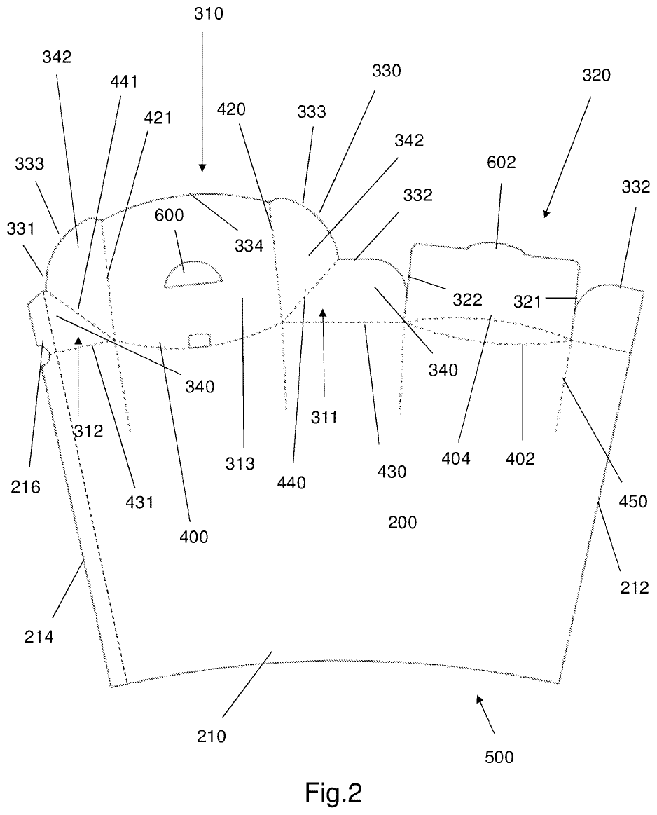

The cup 100 may be a truncated cone when the cup 100 is formed from a blank 500 shown in FIG. 2. The cup 200 comprises a frustoconical shape, as shown in FIG. 1. The cup wall 200 may be formed as a tapered cylinder or a tapering prism having a polygon cross section. The wall 200 tapers inward toward the base such that the base 110 is narrower than the top 120. In an embodiment, the wall 200 forms a tapered cylinder. In an embodiment, the base is circular and the top is substantially circular. In an embodiment, the shape of the cup allows it to be stackable with the base 110 being nestable within the top 120 and thus allowing for a plurality of cups to be stacked together for storage or transportation. Some example embodiments of the cup 100 will be described.

In an embodiment, the cup 100 may comprise a top having a diameter of 62 mm, a height of 62 mm and a base having a diameter 46 mm. In another embodiment, the cup 100 comprises a top having a diameter of 70 mm, a height of 80 mm and a base with a diameter of 46 mm. In another embodiment, the cup 100 comprises a base with a diameter of 46 mm, a height of 92 mm and a top with a diameter of 70 mm. In yet another embodiment, the cup 100 comprises a base with a diameter of 48 mm, a height of 102 mm and a top diameter of 73 mm. In another embodiment, the cup 100 comprises a base with a diameter of 57 mm, a height of 90 mm and a top having a diameter of 80 mm. In another embodiment, the cup comprises a base diameter of 60 mm, a height of 95 mm and a top diameter of 90 mm. In another embodiment, the cup 100 comprises a top diameter of 90 mm, a height of 109 mm and a base diameter of 60 mm. In a Further, embodiment, the cup 100 comprises a base of 60 mm, a top diameter of 90 mm and a height of 111 mm. In another embodiment, the cup 100 comprises a base diameter of 60 mm, a height of 136 mm and a top diameter of 90 mm. In a Further, embodiment, the cup 100 comprises a base diameter of 60 mm, a height of 150 m and a top diameter of 90 mm. The cup may be sized according to any one of the described embodiments. Alternatively, the cup 100 may comprise any other suitable dimensions.

FIG. 1 illustrates an example form of the cup 100. FIG. 2 illustrates a blank 500 of the cup 100 as shown in FIG. 1. The blank 500 defines a two dimensional form of the cup. The blank 500 is two dimensional form of the cup. The blank 500 is a sheet can be used to cut or stamp or punch out a pattern from a material of the cup. The blank 500 is rolled and folded to form the cup as shown in FIG. 1 and the other figures.

Referring to FIG. 1 and FIG. 2, the cup 100 comprises a first closure flap 310 and a second closure flap 320. The first closure flap 310 and second closure flap 320 are integrally formed with the wall 200, as shown in FIG. 2. The first closure flap 310 and the second closure flap 320 extend outward from the wall 200, as shown in FIG. 1 and FIG. 2. The first closure flap 310, the second closure flap 320 and the wall 200 form a single, continuous structure, i.e., a one piece structure. Put another way, the cup (i.e., the closure flaps and the wall) form a monolithic structure. The first closure flap 310 is longer, i.e., has a greater height than the second closure flap 320.

As illustrated in FIG. 2, the first closure flap 310 and the second closure 320 extend upward from the wall 200. The first closure flap 310 is attached to the wall 200 via a first transverse fold feature 400. The second closure flap 320 is attached to the wall 200 via a second transverse fold feature 402. The first closure flap 310 is foldable about the first transverse fold feature 400 and the second closure flap 320 is foldable about the second transverse fold feature 402.

The first closure flap 310 comprises a plurality of parts. Referring to FIG. 1 and FIG. 2, the first closure flap comprises a pair of side flaps 311, 312 and an intermediate flap 313. The first closure flap 310 comprises a first side flap 311 and a second side flap 312. The intermediate flap 313 that extends between the side flaps 311, 312. The intermediate flap 313 connects the two side flaps 311, 312. Each side flap 311, 312 is attached on opposing edges of the intermediate flap 313 at a longitudinal fold feature. The first side flap 311 is attached to the intermediate flap 313 at a first longitudinal fold feature 420. The second side flap 312 is attached to the intermediate flap at a second longitudinal fold feature 421. The longitudinal fold features 420, 421 extend vertically on the first closure flap 310.

The first side flap 311 is attached to the wall 200 at a first side fold feature 430. The second side flap 312 is attached to the wall 200 at a second side fold feature 431. The intermediate flap 313 is attached to the wall at the first transverse fold feature 400. The first side flap 311, second side flap 312 and the intermediate flap 313 are formed as a one-piece structure.

Each side flap 311, 312 comprises an arcuate edge. The first side flap 311 comprises a first arcuate edge 330. The second side flap 312 comprises a second arcuate edge 331. The arcuate edges 330, 331 may be identical or substantially similar to each other in size and shape. The side flaps 311, 312 are identical or substantially similar to each other in size and shape. The arcuate edge 330, 331 of each side flap comprises a first curved portion 332 and a second curved portion 333, the two curved portions define the arcuate edge. The first curved portion 332 and the second curved portion 333 each have different arc lengths, i.e., perimeter lengths. In the illustrated example the second curved portion 333 is longer than the first curved portion. The intermediate flap 313 also comprises a curved edge 334. The arcuate edges 330, 331 and the curved edge 334 define a free edge of the first closure flap 310. The arcuate edges 330, 331 and the curved edge are free edges.

Each side flap 311, 312 comprises a distal panel 340 and a proximal panel 342. The proximal panel 342 of each side flap is proximal to the intermediate flap 313. The distal panel 340 is distal to the intermediate panel 313. The first closure flap 310 comprises two oblique fold features 440, 441. Each side flap comprises an oblique fold feature. The oblique fold feature 440, 441 separates the proximal panel 342 and the distal panel 340. Each side flap 311, 312 can be folded along the oblique fold feature 440, 441. In use, each side flap 311, 312 folds about the side fold feature 430, 431.

The first transverse fold feature 400 comprises a curved shape. The first transverse fold comprises an arc. The first transverse fold feature 400 comprises a concave curve. Concave in this context meaning curved toward the base 110, i.e., lower edge 210 of the wall. The lower edge 210 of the wall is an arcuate shape. The lower edge 210 comprises a convex curve, i.e., curved toward the top 120. The lower edge 210 is used to form the base 110 or alternatively a separate part, e.g., a disc of material is attached to the lower edge 210 as part of forming the cup.

The cup 100 comprises a third transverse fold feature 404. The third transverse fold feature 404 is disposed on the second closure flap 320. The second transverse fold feature 404 is located adjacent the second transverse fold feature 402. The second transverse fold feature 402 and the third transverse fold feature 404 are curved. The two transverse fold features 402, 404 comprise opposing curves. In the illustrated embodiment, the second transverse fold feature 402 comprises a concave curve. The third transverse fold feature 404 comprises a convex curve.

As shown in FIG. 1 and FIG. 2, the first closure flap 310 comprises a locking opening 600. The locking opening 600 may be a semi-circular shape. The locking opening 600 may comprise another suitable shape such as for example a crescent shape. The locking opening 600 is a cut out within the first closure flap 310. The second closure flap 320 comprises a locking tab 602. The locking tab 602 extends outwardly from the free edge 334 of the second closure flap 320. In an embodiment, the free edge 334 is a straight edge but may include a curvature within it when the cup 100 is formed by rolling the wall 200.

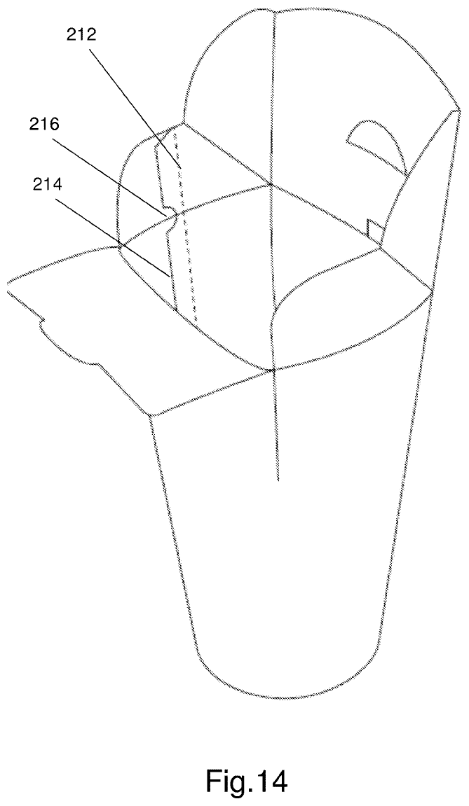

The wall 200 comprises a first longitudinal edge 212 and a second longitudinal edge 214. The second longitudinal edge 214 may comprise a C shaped cut out 216. The C shaped cut out 216 is positioned at a side fold feature when the first longitudinal edge 212 and second longitudinal edge 214 are overlapped to form the cylinder or prism, as shown in FIG. 14. The C shaped cut out 216 helps to reduce stiffness for folding thereby allowing both side flaps 311, 312 to be folded with a similar force applied by a user. This makes folding the side flaps and folding the first closure flap 310 more intuitive and easier. The C shaped cut out may be an optional feature.

The wall Further, comprises one or more vertical fold features 450 formed on and/or within the wall 200. As shown in at least FIG. 1 and FIG. 2, the wall 200 comprises four vertical fold features 450. The vertical fold features extend a partial distance along the wall. The vertical fold features 450 extend longitudinally along the wall 200, i.e., parallel to a longitudinal axis of the wall 200. Two vertical fold features align with longitudinal fold features 420, 421. The other two vertical fold features extend away from the second closure flap 320 and align with the vertical edges 321 and 322 of the second closure flap 320. The four vertical fold features 450 help to make rolling the wall 200 easier. The wall can be folded or rolled to attach the two longitudinal edges 214, 212 together. The vertical fold features 450 help to make rolling the wall 200 easier. The vertical fold features 450 may be lines or weakened areas.

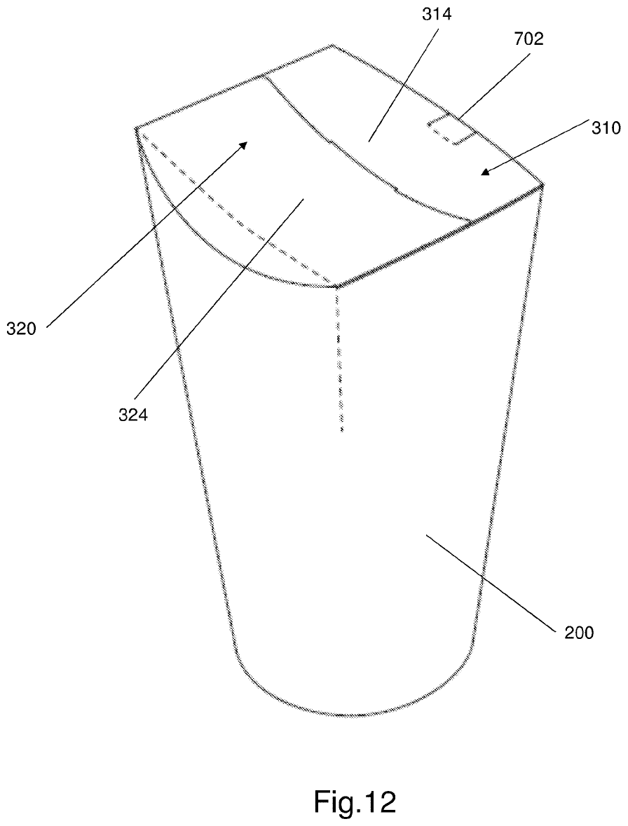

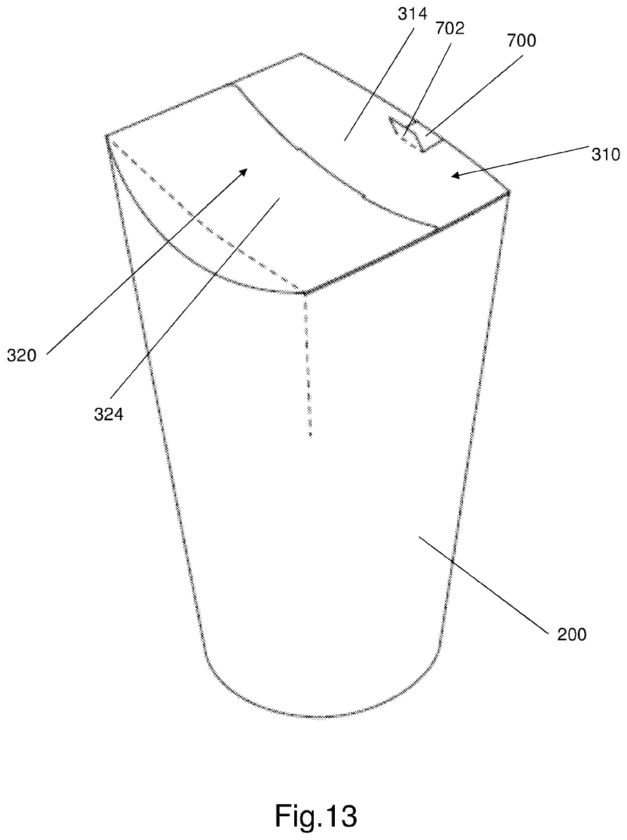

The cup 100 Further, comprises an outlet opening 700 and a foldable cover 702, as shown in FIG. 12 and FIG. 13. The foldable cover 702 is moveable between a closed and open position The outlet opening 700 being exposed when the cover 702 is an open position. The outlet opening 700 is accessible by a user when the cover 702 is in the open position such that contents of the cup can exit out of the opening 700. The outlet opening 700 is covered by the cover 702 when the cover is in the closed position.

The cup 100 is formed using an automated process. The cup 100 may be formed by a cup forming machine. The blank 500 can be used as a pattern to stamp or cut out the blanks shape. The cup 100 is formed by rolling the wall and attaching the longitudinal edges 212, 214 to each other. The longitudinal edges 212, 214 may be adhered together or welded together. The vertical fold features 450 can help in rolling the wall to create the frustoconical shape of the cup 100. The blank 500 can be used to cut out multiple patterns to form multiple cups 100.

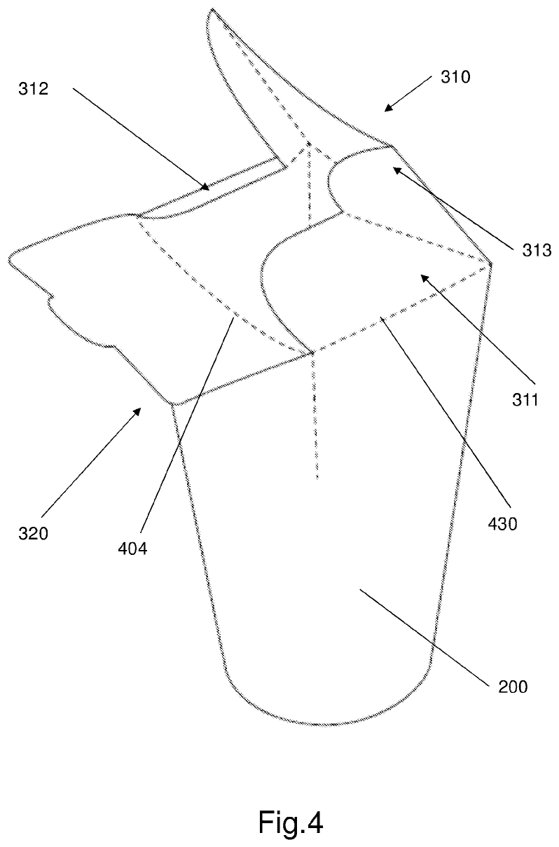

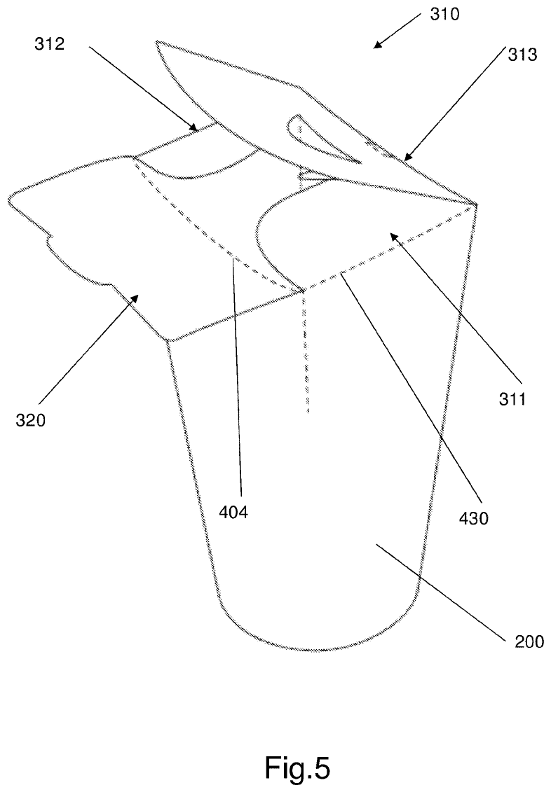

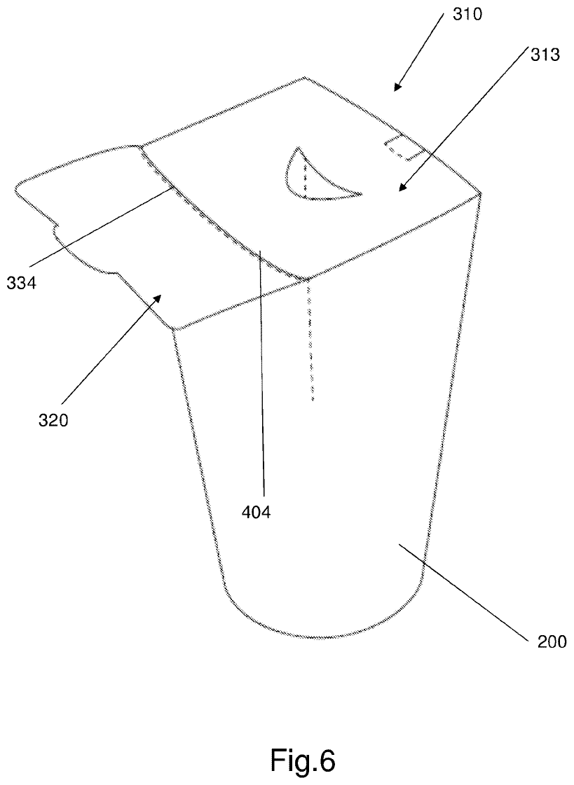

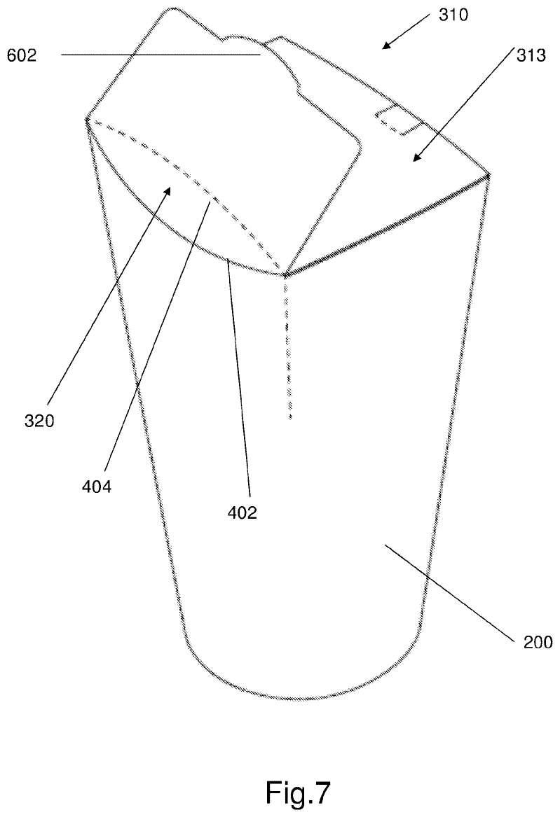

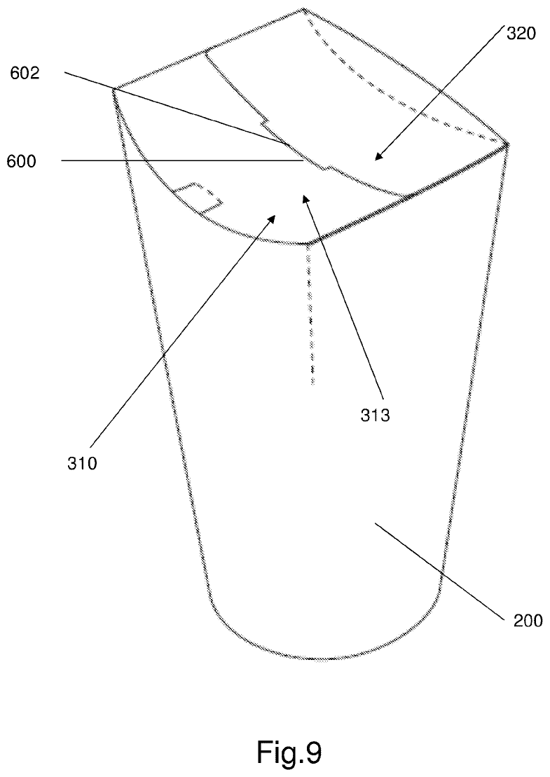

The use of the cup 100 will now be described. The lid 300 is formed by folding the first closure flap 310 and the second closure flap 320. The first closure flap 310 is folded twice to move the first closure flap 310 to a closed position. The second closure flap 320 is folded once to move the second closure flap 320 to a closed position. FIGS. 4 to 6 illustrate the process of folding the first closure flap 310 to a closed position. The lid 300 is formed by a three-fold arrangement. The first closure flap 310 is folded twice and the second closure flap 320 is folded once to close the lid. FIG. 4 illustrates a first fold of the first closure flap 310. The first closure flap is folded along the oblique fold features 440, 441. FIG. 5 shows the second fold of the first closure flap 310, where the first closure flap is folded about the first transverse fold feature 400. FIG. 6 illustrates the folded position of the first closure flap 310. FIG. 7 shows the second closure flap 320 is folded about the second transverse fold feature 402. FIG. 9 shows the lid in the closed position.

Referring to FIG. 4, the first closure flap is folded along the side fold features 430, 431, and the transverse fold feature 400. In particular, the side flaps 311, 312 are folded inward, i.e., toward each other along the side fold features 430, 431. The intermediate flap 313 is folded inward along the transverse fold feature.

The first closure flap 310 is folded about the oblique fold features 440, 441 as shown in FIG. 4 and FIG. 5. Each side flap 311, 312 is folded about the oblique fold features 440, 441 to create the second fold of the first closure flap 310. The folding about oblique fold features 440, 441 creates a pair of opposing arcuate lips. The opposing inward pointing arcuate lips are defined by the arcuate edge 330, 331 of each side flap 311, 312. The intermediate flap 313 is folded along the oblique fold features 440, 441 and the transverse fold feature 400. The arcuate edge 330, 331 of each side flap and the curved edge 334 of the intermediate flap form a folded flap. The edges of the side flaps and the intermediate flap forms three faces and three lips create sealing structures to prevent the contents of the cup from spilling out when the cup is tipped or tilted to a drinking orientation or when tipped toward the intermediate flap. The proximal and distal panels of each side flap 311, 312 and the intermediate flap 313 have a distance such that when folded into a closed position, the flaps overlap each other.

FIG. 6 shows the fully closed orientation of the first closure flap 310 (i.e., a closed position of the side flaps 311, 312 and the intermediate flap 313). As shown in FIG. 5, the side flaps 311, 312 are folded inward and the arcuate edges 330, 331 are folded toward each other. The intermediate flap 313 rests on top of the folded side flaps 311, 312. The first curved portion 332 of each side flap 311, 312 are longer than the second curved portion 333. The first curved portion 332 of each side flap 311, 312 extend closer to each other when in the folded position, as compared to the second curved portions 333 of each side flap 311, 312. The two curved portions 332, 333 create curved sealing surfaces to prevent contents of the cup spilling out.

The curvature of curved edge 334 of the intermediate flap 313 corresponds to the curvature of the second transverse fold feature 402 as shown in FIGS. 1, 5 and 6. As shown in FIG. 6, the intermediate flap 313 has a length that extends across the top such that the curved edge 334 of the intermediate flap 313 rests in contact with the second transverse fold feature 402. FIG. 6 shows the intermediate flap 313 extending the top 120 and extending from one side to the other side of the cup to shut off the cup.

FIG. 6 shows the matching curvature of the second transverse fold feature 402 and the curved edge 334 of the intermediate flap 313. The matching curvature is advantageous because this improves sealing of the cup and helps to prevent or at least reduces the chances of the contents of the cup from leaking out.

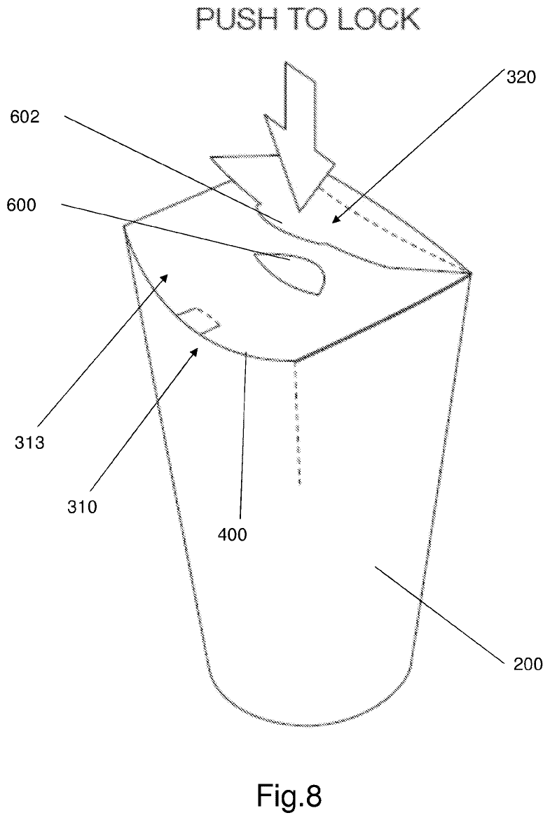

The second closure flap 320 is folded about the second transverse fold feature 402, as shown in FIG. 7. The second closure flap 320 rests on top of the intermediate flap 313, as shown in FIG. 9. The locking tab 602 is pushed into the locking opening 600, as shown in FIG. 8. Further, a downward force is applied by the user to insert the locking tab 602 into the locking opening 600. The locking tab received into the locking opening locks the second closure flap 320 to the first closure flap 310, thereby locking the lid into a closed position.

The second fold feature 402 being concave shaped allows for easy folding of the second closure flap 320 to a closed position and allows a user to easily engage the locking tab 602 into the locking opening 600. The second fold feature 402 being concave in shape allows a user to fold the second closure flap 320 without upsetting the folded first closure flap 310 and reduces the force required to fold the second closure flap 320 and lock the flap 320.

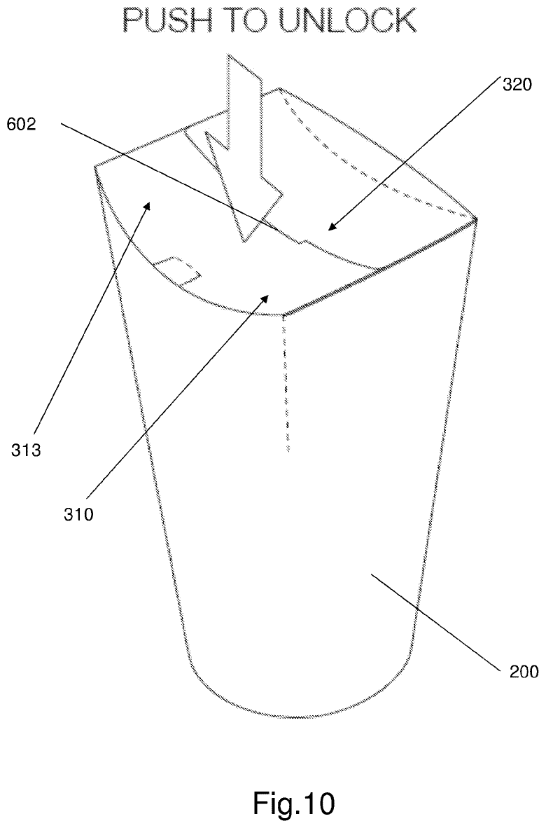

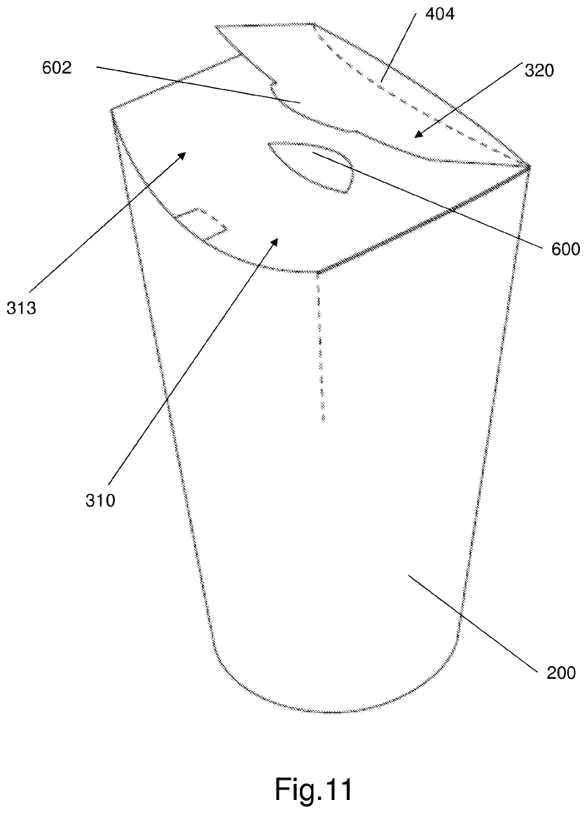

The locking tab 602 can be unlocked from the locking opening 600 by applying a force on an upper surface of the lid 300, as shown in FIG. 10. More specifically to open the lid 300, the user can apply a force (i.e., push down) on the second closure flap 320 when in the folded arrangement as denoted by the arrow shown in FIG. 10. The locking tab 602 is removed from the locking opening 600, and the second closure flap 320 moves upward as shown in FIG. 11. The second closure flap 320 is biased upward due to the concave shape of the second transverse fold feature 402. This concave shape of the fold feature 402 provides additional tension to form a better seal.

In an embodiment, audible feedback or tactile feedback is provided when the locking tab 602 is engaged into the locking opening 600. Further, audible feedback or tactile feedback is provided when the locking tab 602 is disengaged from the locking opening 600. The audible feedback comprises an audible click which is generated due to the curved upper surface of the first closure flap 310 and a curved upper surface of the second closure flap 320. The audible click is also due to the second closure flap 320 being biased upward, i.e., the second closure flap expands and retracts to create the clicking sound. The closure flap 320 expands, i.e., moves upward due to it being biased upward.

The locking opening 600 is shown in this example as a cut out aperture. However, the opening 600 may take other forms including a slit, cut, slot or any other receiving structure that can be cut or pressed into the flap so as to receive the locking tab 602.

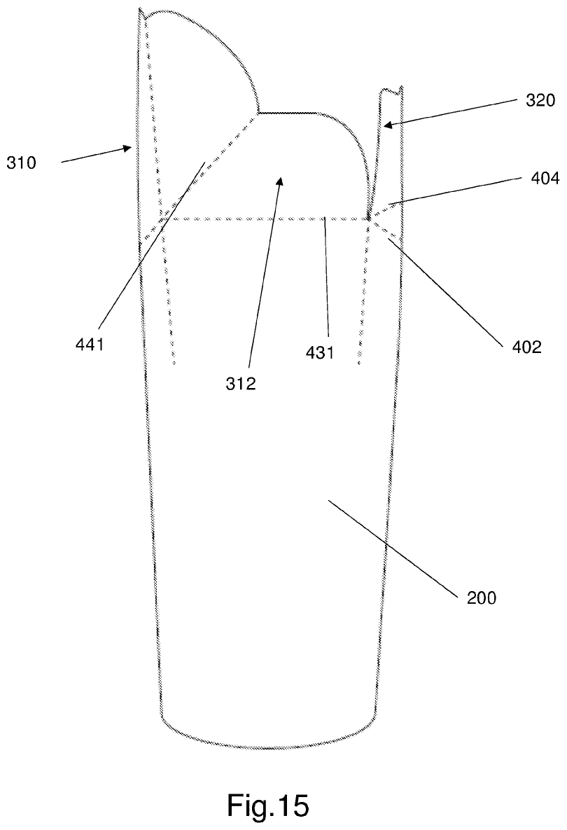

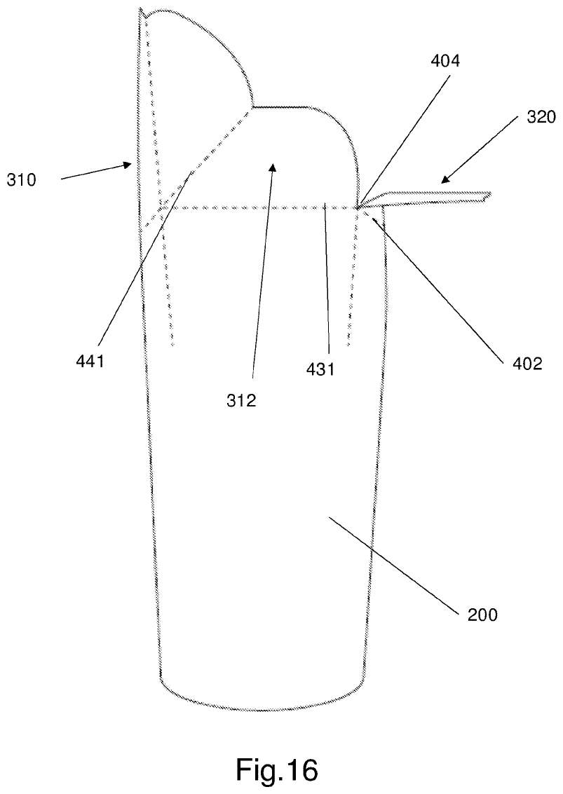

The second closure flap 320 can be folded back. The second closure flap 320 is configured to be folded between 0 degrees and 180 degrees. The second closure flap 320 is in a fully open position when the second closure flap is at 0 degrees, as shown in FIG. 2 and FIG. 16. The second closure flap 320 is in a closed position when the second closure flap is at 180 degrees as shown in FIG. 9 and FIG. 10. The second closure flap 320 is perpendicular to the first closure flap 310 when at 0 degrees, as shown in FIG. 16. The second closure flap 320 can also be positioned at 90 degrees as shown in FIG. 15.

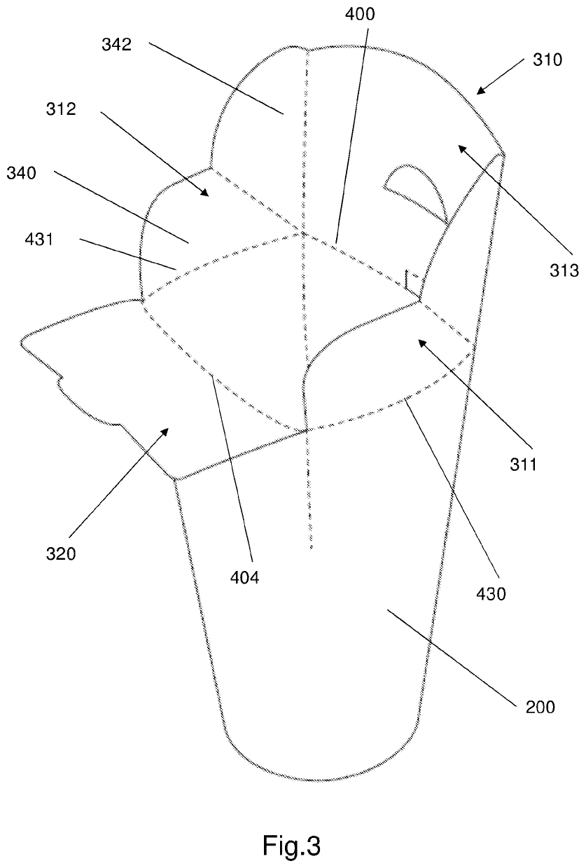

The third transverse fold feature 404 is disposed on the second closure flap 320. The third transverse fold feature 404 is positioned adjacent the second transverse fold feature 402. The second closure flap 320 is foldable about the third transverse fold feature to allow the second closure flap to move between 0 degrees and 180 degrees and any position between 0 degrees and 180 degrees is relative to a horizontal. As shown in FIG. 3 and FIG. 16 when the second closure flap 320 is in fully folded back, i.e., at 0 degrees, a user can view inside the cup and determine a fill level of the cup. The folded back second closure flap 320 allows a user to view the fill level as the cup is being filled, e.g., by a drinks dispenser. Additionally, the second closure flap 320 may also be folded back by a user so as to open the cup whilst forming a lip for a user to drink or access the contents directly from the cup.

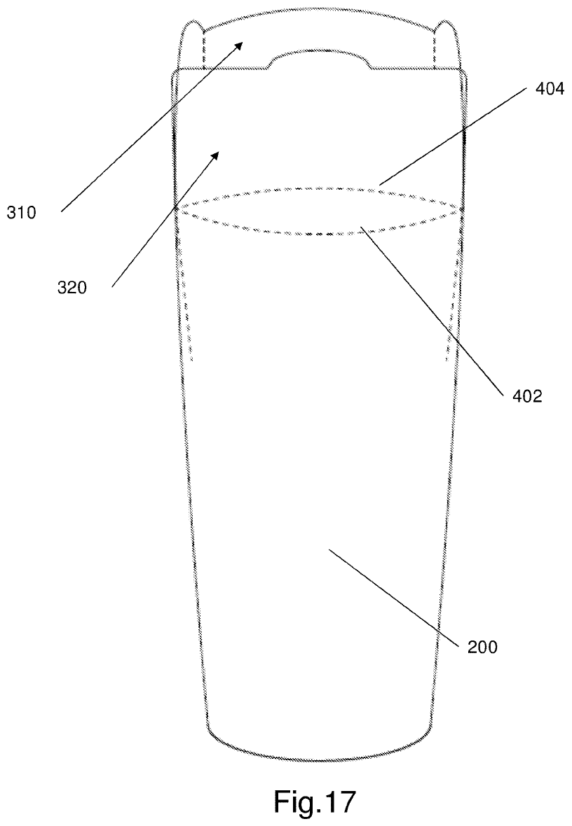

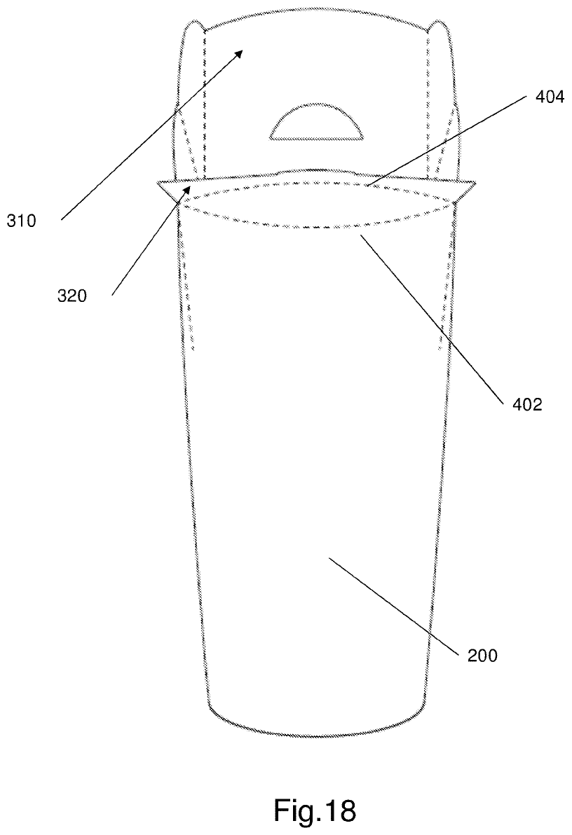

FIGS. 17 and 18 show a front view of the cup. FIG. 17 shows the second closure flap 320 at a 90 degrees position relative to a horizontal. FIG. 17 shows the second transverse fold feature 402 and the third transverse fold feature 404. The second transverse fold feature 402 and the third transverse fold feature 404 are curved. The two fold features are curved in opposed directions. FIG. 17 more clearly illustrates the convex curve of the third transverse fold feature 404 and the concave curvature of the second transverse fold feature 402. As shown in FIG. 18, which is a front view of FIG. 16, the second closure flap 320 is folded about the third transverse fold feature to a 0 degrees position, i.e., the closure is folded back to expose the hollow space 202.

The second transverse fold feature 402 and the third transverse fold feature 404 comprise opposing curvatures. The third transverse fold feature 404 is a convex shaped curvature and the second transverse fold feature 402 is a concave fold feature 402. The convex shaped third transverse fold feature 404 allows the second closure flap 320 to be folded back without upsetting or disrupting the rest of the structure, e.g., the folded first flap 310. FIG. 16 illustrates the folded back position of the second flap 320. FIGS. 4 to 6 illustrate the second closure flap 320 in the folded back position while the first closure flap 310 is folded without any interference.

FIGS. 12 and 13 illustrate the outlet opening 700 and the foldable cover 702. FIG. 12 shows the cover 702 in a closed position and the outlet opening 700 being covered. FIG. 13 illustrates the cover 702 in an open position and the outlet opening 700 being accessible by a user. The outlet opening 700 and cover 702 remain closed due to the curvature of the first closure flap 310 and second closure flap 320. The cover 702 has to be manually opened thereby reducing the chances of accidental spillage through the outlet opening 700. The cover 702 in combination with the arcuate lips formed by the folded side flaps improves sealing of the cup. The outlet opening 700 is sized to allow a straw or stirrer to be placed into the cup. The opening 700 is sufficiently sized to allow a user to drink through it.

FIG. 14 illustrates the longitudinal edges being overlapped to form a cylinder or prism shape to define the container. The second longitudinal edge 214 comprises a cut out 216. The cut out 216 is a C shaped cut out. The C shaped cut-out 216 is positioned at a side fold feature when the first longitudinal edge and second longitudinal edge are overlapped to form the cylinder or prism, the C shaped cut out improving foldability of each side flap. The C shaped cut out reduces the stiffness of the side flaps, therefore making folding of the side flaps easier. The side flaps 311, 312 can be folded with a similar force applied by the end user, making forming the lid easier.

FIGS. 12 and 13 illustrate a closed embodiment of the lid 300. The lid 300 comprises a curved upper surface. The upper surface of the lid 300 is curved inward, i.e., a concave curvature. As shown in FIGS. 12 and 13, the first closure flap 310 and the second closure flap 320 each comprise a curved upper surface. The upper surface 314 of the first closure flap 310 and an upper surface 324 of second closure flap are curved in the same direction. The first closure flap 310 and the second closure flap 320 comprise a concave curvature, i.e., the flaps are curved inward. More specifically the intermediate flap 313 of the first closure flap and the second closure flap 320 comprise a concave curvature, as shown in FIG. 12 and FIG. 13.

In an embodiment, the cup 100 may include straight side edges. Each side fold feature 430, 431 are defined along a straight edge of the wall 200. The upper surface 314 of the first closure flap and the upper surface of the second closure flap comprise a concave curvature. The straight edges at each side of the cup allows for easier folding as the tension on the side flaps is in one direction. The concave curvature of the first closure flap 310 and the second closure flap 320, along with the straight edges creates a tension, i.e., a biasing force inward to make folding the closure flaps easier. Further, the concave curvature of the upper surfaces allows for a user's nose to be received within the space formed by the curved surface to make drinking easier from the cup 100.

The cup 100 described herein provides several advantages as described herein. The shape and structure of the cup 100 allows for easier closure of the lid. The cup comprises a first and second closure flap that define the lid. The closure flaps are integrated with the wall of the cup therefore making an integrated lid. The first closure flap is folded twice and the second closure flap is folded once to create a closed lid as shown in FIG. 12. The three fold arrangement allows for an easy closure method. The first closure flap comprises two side flaps with arcuate edges, i.e., arcuate free edges. The side flaps are folded inwards and the arcuate edges create multiple, overlapping sealing edges. The side flaps and intermediate flaps being positioned on top of each other, create multiple sealing faces thereby reducing the chances of leakage from the cup. The second closure flap can be folded right back to allow easier viewing of the contents of the cup. The cup comprises two fold features with two opposing curves. This allows the second closure flap to be folded along 180 degrees therefore allowing the second closure flap to close and completely open.

The term fold feature or folding feature as describe herein define fold structures that allow a flap to fold about the fold feature. The fold features may be fold lines. Alternatively, the fold features may be weakened areas of the flap or wall or other structure of the cup. For example, the fold features may be half-cut curves and/or lines, perforated curves and/or lines.

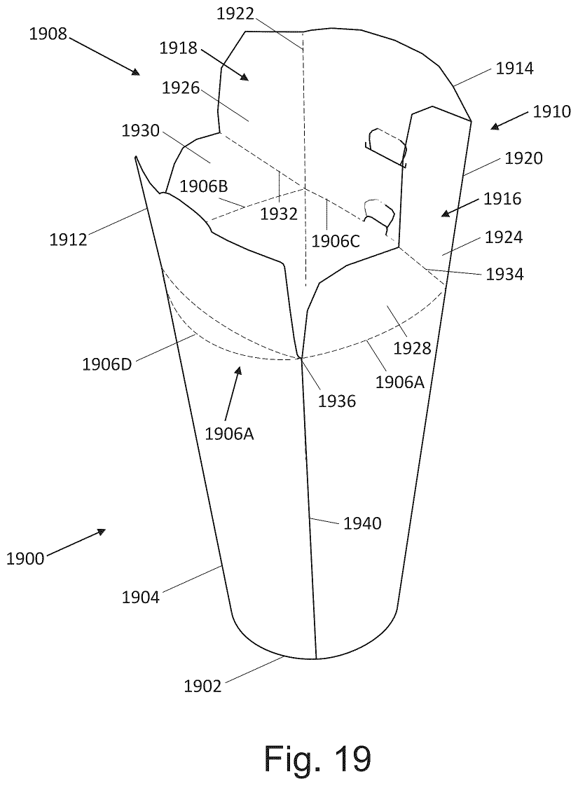

FIG. 19 illustrates an exemplary cup 1900 for retaining a liquid or a solid within it. The cup 1900 comprises a base 1902 and wall 1904. The wall 1904 is attached to the base 1902 and extends upward from the base 1902. The wall 1904 terminates at a rim 1906.

It is noted that the term rim is used to aid description and to relate the cup 1900 to a standard cup. The term rim encompasses a shape of the cup 1900 when the lid is in a closed embodiment, i.e., when the cup is in use as a drinking vessel. The term rim need not mean that an edge is formed, but can be related to the portion of a standard cup where an edge and an opening would be formed.

The wall 1904 is a continuous wall. The base 1902 is generally circular. The rim 1906 is generally rectangular. The rim 1906 may have a ‘squashed’ rectangular shape, in which two opposed sides are straight and the two other opposed sides are arced. In one example, the two arced sides are bowed outwards. The two arced sides may be the front side and the rear side. The two straight sides may be the lateral sides. The sides of the generally rectangular rim 1906 are formed by fold lines 1906A-D when the lid arrangement 1908 is closed.

The cup 1900 comprises a closable lid arrangement 1908. The lid arrangement 1908 is integrated with the wall 1902 and extends from the rim 1906. The lid arrangement 1908 may be folded to a closed position and unfolded to an open position.

The lid 1908, the wall 1904, and the base 1902 may all be formed from the same material. For example, in one form, the cup 1900 may be formed from paper or paperboard. In another form, the cup 1900 (i.e., the base 1902, wall 1904, and the lid 1908) may be formed from cardboard. In a further form, the cup 1900 may be formed from a natural fibre material, e.g., jute. In a further form, the cup 1900 may be formed from a composite material comprising natural fibres and synthetic fibres. In a further form, the cup 1900 may be formed from a plastic material or a polymer, e.g., a thermoplastic polymer. In a further form, the cup 1900 may be formed from a recycled plastic material or a recyclable plastic material.

The cup 1900 may be any suitable size. The cup 1900 may be sized to have a volume of between 4 oz and 20 oz. For example, the cup 1900 may be sized to have a volume of any one of 4 oz, 5 oz, 6 oz, 7 oz, 8 oz, 9 oz, 10 oz, 12 oz, 16 oz, or 20 oz. Alternatively, the cup 1900 may be sized and shaped to define any suitable volume.

The shape of the cup allows it to be stackable with the base 1902 being nestable within the rim 1906, and thus allowing for a plurality of cups to be stacked together for storage or transportation.

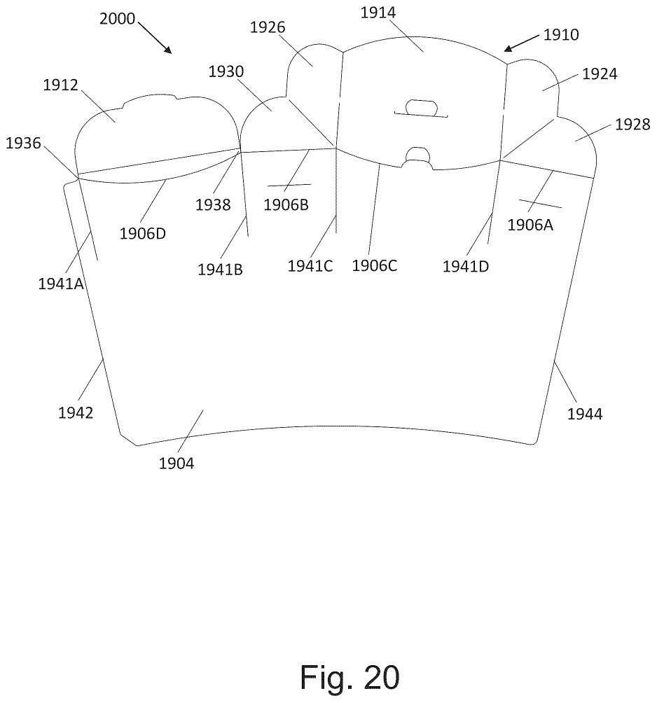

Referring to FIG. 19 and FIG. 20, the lid arrangement 1908 comprises two flaps: a first closure flap 1910 and a second (rear) closure flap 1912. The first closure flap 1910 and the second closure flap 1912 extend vertically from the rim 1906 in a direction continuing from a direction in which the wall 1904 extends from the base 1902. The first closure flap 1910 extends around three sides of the generally rectangular rim 1906. In the example shown in FIG. 19, the first closure flap 1910 extends around a front side and the two lateral sides of the rim 1906.

The first closure flap 1910 includes a front flap 1914 and two side flaps 1916, 1918. The front flap 1914 is foldable relative to the wall 1904 about a fold line 1906C, which forms the front side of the rim 1906. The side flaps 1916, 1918 are adjacent to the front flap 1914 and opposite each other. The side flaps 1916, 1918 are foldable relative to the wall 1904 about fold lines 1906A and 1906B, which form lateral sides of the rim 1906. The front flap 1914 extends along an arced side of the generally rectangular rim 1906. The second closure flap 1912 is foldable relative to the wall 1904 about a fold line 1906D that forms the rear side of the rim 1906 and is opposite the front flap 1914. The rear fold line 1906D may be arced.

Each of the flaps of the lid arrangement 1908 is foldable along a fold line coincident with a corresponding portion of the rim 1906. In addition, each of the side flaps 1916, 1918 is foldably connected to the front flap along vertical fold lines 1920, 1922. Further, each side flap 1916, 1918 is split into a front portion 1924, 1926 and a rear portion 1928, 1930. The front portions 1924, 1926 are connected to the front flap 1914 by the vertical fold lines 1920, 1922. The rear portions 1928, 1930 are connected to the wall 1904 by the lateral fold lines 1906A, 1906B. The front portions 1924, 1926, and rear portions 1928, 1930 of each side flap 1916, 1918 are foldably connected along oblique fold lines 1932, 1934.

The rear flap 1912 is adjacent to the rear portions 1928, 1930 of the side flaps 1916, 1918 at two corners 1936, 1938 (not seen in FIG. 19) of the generally rectangular rim 1906. The rear flap 1912 is not connected to the side flaps 1916, 1918. Notches are formed at the corners 1936, 1938, where the rear flap 1912 and the rear portions 1928, 1930 of the side flaps 1916, 1918 extend downwards to the rim 1906. The rear flap 1912 is foldable independently of the side flaps 1916, 1918. The rear flap 1912 is not connected to the side flaps.

A side seam 1940 is formed on the wall 1904. The seam 1940 is a result of creating the cup 1900 from a blank 2000, shown in FIG. 20. The blank 2000 is wrapped around so that an edge 1942 meets an edge 1944, thereby creating the seam 1940 when the edges are joined. It will be seen that the edge 1942 extends further than is necessary so as to form a flap that overlaps and is adhered to a corresponding portion of the wall 1904 at the edge 1944.

The seam runs from a corner 1936 of the rim 1906, where the rear flap 1912 is adjacent to one of the side flaps 1916, 1918. As a result, the seam stops at the rim 1906 and does not extend into the lid arrangement 1908. Accordingly, the seam 1940 does not interfere with the closing of the lid arrangement 1908.

If the seam 1940 were positioned such that it extended to the base 1902 from any other part of the rim 1906, then it would extend into the first flap 1910 or the second (rear) flap 1912. Because the seam 1940 is double the thickness of the wall 1902, this would make folding the flaps 1910, 1912 more difficult and would lead to a greater chance of liquid leaking out of the lid 1908 when it is closed.

The wall 1904 also includes rim forming fold lines 1941A-D. These help create the substantially rectangular rim 1906 by encouraging the corners to be formed as the blank 2000 is formed into the cup 1900.

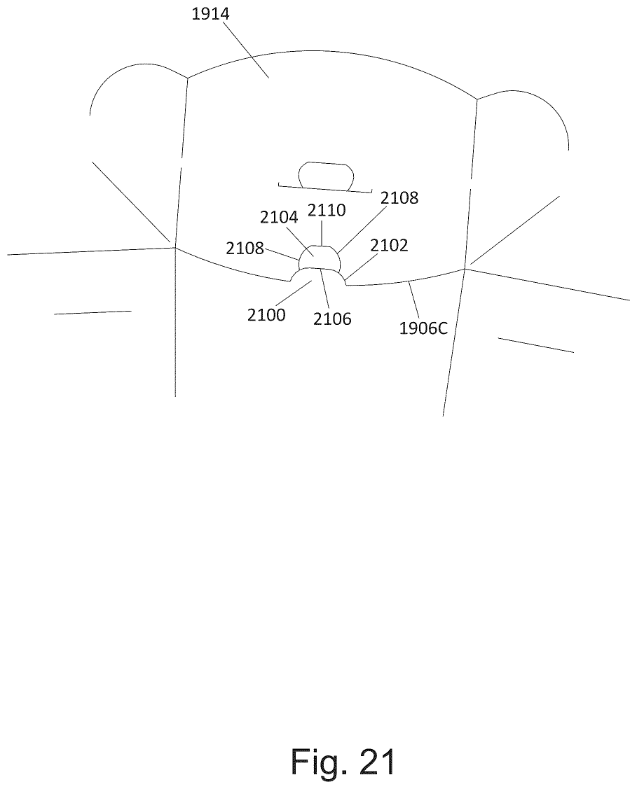

FIG. 21 shows an enlarged view of the front flap 1914 of the cup 1900 (and the blank 2000). The front flap 1914 includes a spout portion 2100. The spout portion 2100 is configured to remain in position when the remainder of the front flap 1914 is folded inwards when closing the lid arrangement 1908. That is, the spout portion 2100 remains in a position extending from the rim 1906 in a direction aligned with the wall 1904 when the front flap 1914 is folded inwards.

The front flap 1914 is connected to the wall 1904 along a front fold line 1906C that forms an arced front side of the generally rectangular rim 1906. The fold line 1906C is interrupted at the spout portion 2100. The fold line 1906C stops at the spout portion 2100. The spout portion 2100 is a continuous extension of the wall 1904. The spout portion 2100 is not joined to the wall 1904 by a fold line. An outer edge 2102 of the spout portion 2100 extends into the front flap 1914 and comprises a cut line or an otherwise frangible connection configured to break under a force applied to the front flap 1914 when folding it inwards. Therefore, as the front flap 1914 folds, the spout portion 2100 remains in position. This leaves an aperture in the front flap 1914 where the spout portion 2100 was previously, and forms an extended spout to aid drinking.

The fold line 1906C (and corresponding side of the generally rectangular rim 1906) may be arced downwards in a plane transverse to the base 1902. This creates tension in the folded front flap 1914 that biases the front flap 1914 into a locked position when closed, as explained below. The fold line 1906C may be arced and bowed outwards in a plane parallel to the base 1902 to create a singly curved inner face of the spout portion 2100 when the lid arrangement 1908 is closed. This provides additional stability to the spout portion 2100 in use.

The front flap 1914 includes an aperture enlargement portion 2104. The aperture enlargement portion 2104 extends from the outer edge 2102 of the spout portion 2100 into the front flap 1914. A part 2106 of the outer edge 2102 of the spout portion 2100 forms a part of an edge of the aperture enlargement portion 2104. A Further, part 2108 of the outer edge of the aperture enlargement portion 2104 is formed by a cutline or a frangible connection between the aperture enlargement portion 2104 and the front flap 1914. The aperture enlargement portion may be pushed through on application of a force in an inward direction by a user to form an enlarged aperture, for example, by pushing a straw into the aperture enlargement portion 2104 when the lid arrangement 1908 is closed. In the exemplary arrangement shown, a Further, part 2110 of the outer edge of aperture enlargement portion 2104 is foldably connected to the front flap by, for example, a fold line or other foldable connection.

The outer edges 2108, 2110 of the aperture enlargement portion 2104 (and therefore the enlarged aperture) may be sized to accommodate a particular straw with a tight, or interference fit. That is, the dimensions of at least a part of the aperture enlargement portion (and enlarged aperture) may have broadly the same dimensions as a particular straw. Accordingly, the straw may be supported by an outer edge of the enlarged aperture during use.

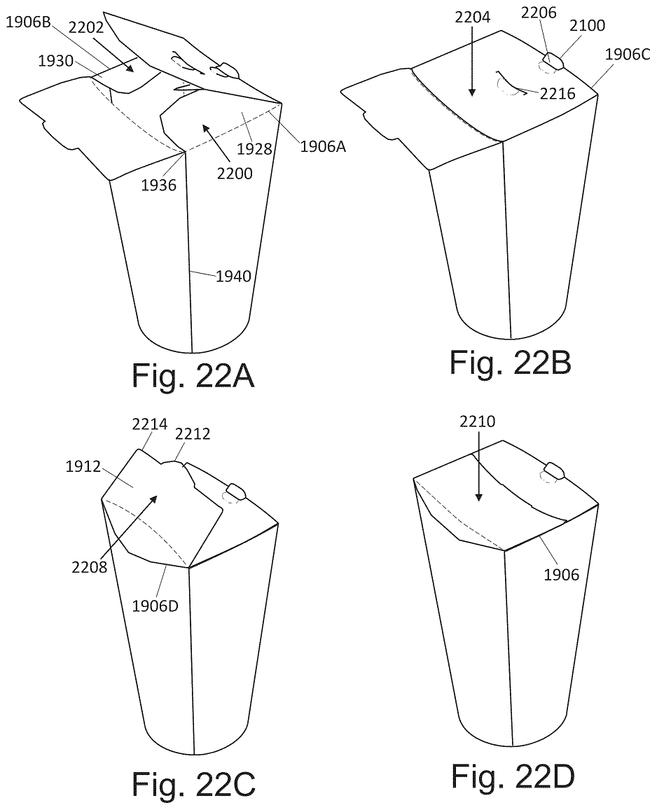

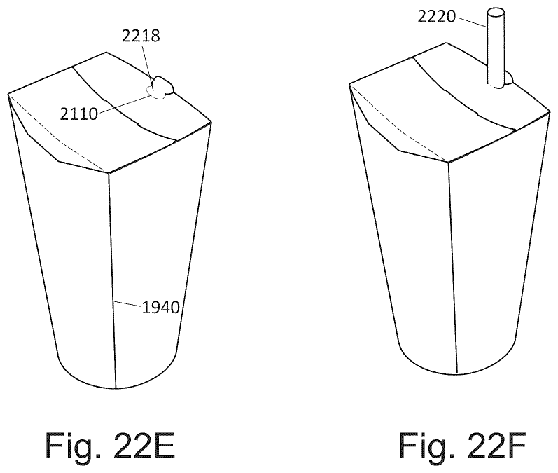

FIGS. 22A-22F show the operation of the lid arrangement 1908 of the cup 1900.

Referring to FIG. 22A, the rear portions 1928, 1930 of the side flaps 1916, 1918 are folded inwards about the fold lines 1906A, 1906B under a force applied in the direction of arrows 2200, 2202. The connection of the rear portions 1928, 1930 to the front portions 1932, 1934 of the side flaps 1916, 1918 along the oblique fold lines 1934, 1936 causes the front portions 1924, 1926 to fold inwards relative to the front flap 1914 along the vertical fold lines 1920, 1922 under the force 2200, 2202 applied to the rear portions 1928, 1930. The front panel 1914 folds inwards about the fold line 1906C under the force 2200, 2202 applied to the rear portions 1928, 1930.

The seam 1940 extends from the corner 1936 towards the base. The corner 1936 of the rim 1906 is one of the corners 1936, 1938 at which the side flaps 1916, 1918 and the rear flap 1912 terminate. This means that the side flaps 1916, 1918 and the rear flap 1912 may be folded inwards without interference from the seam 1940.

Referring to FIG. 22B, a downward force 2204 is applied to the front flap 1914 to close it. The front portions 1924, 1926 and rear portions 1928, 1930 of the side flaps 1916, 1918 fold under the front flap 1914. The spout portion 2100 remains upright and extends from the fold line 1906C. This leaves an aperture 2206 in the closed front flap 1914 out of which liquid retained in the cup 1900 may flow.

Referring to FIG. 22C, the rear flap 1912 is folded inwards, over the front flap 1914, about the fold line 1906D under a force 2208 applied by the user. Because the seam 1940 extends towards the base 1902 from the corner 1936, it does not interfere with the folding of the rear flap 1912. The rear flap 1912 is folded over to meet the front flap 1914 and pushed downwards under a force 2210, applied by the user. As the rear flap 1912 and the front flap 1914 are pushed below the height of the rim 1906, a tongue 2212 extending from a distal edge 2214 of the rear flap 1912 locates within a slit 2216 in the front flap 1914. The arced fold lines 1906C, 1906D, about which the front flap 1914 and the rear flap 1912 are folded, form the front flap 1914 and rear flap 1912 into single curved surfaces when they are in the closed position. This generates tension in the front flap 1914 and rear flap 1912 that biases them in an upwards direction, locking the lid arrangement 1908 closed.

In FIG. 22E, the aperture enlargement portion 2104 has been pushed through such that it folds inwards about the foldable connection of the aperture enlargement portion 2110. This creates an enlarged aperture 2218 in the front flap 1914. In FIG. 22F, a straw 2220 has been inserted into the enlarged aperture 2218. The insertion of the straw 2220 may be used to push through the aperture enlargement portion 2104.

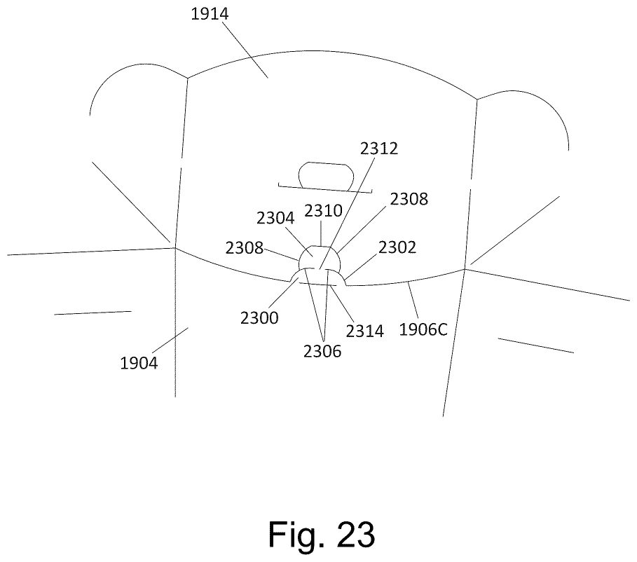

Referring to FIG. 23, a section of an exemplary blank for making a cup is shown. Other than the features discussed below, the features of the blank may be the same as those of the blank of FIGS. 20 and 21. Such features are not described again here.

A front flap 1914 of the blank includes a spout portion 2300. The spout portion 2300 extends into the front flap 1914 from the rim 1906. In specific arrangements, the spout portion 2300 extends from a front fold line 1906C of the rim 1906. In the exemplary arrangement shown in FIG. 23, the front fold line 1906C is interrupted at the spout portion 2300. That is, the front fold line 1906C does not extend across the base of the spout portion 2300. In some arrangements, this may mean that the spout portion 2300 remains in position when the front flap 1914 is folded over to form a part of the lid of the cup. In other arrangements, the connection between the spout portion 2300 and the wall 1904 may be foldable and may include a fold line.

An outer edge 2302 of the spout portion 2300 is separated from the front flap 1914 by a cutline. The front flap 1914 includes an aperture enlargement portion 2304. The aperture enlargement portion 2304 extends from the outer edge 2302 of the spout portion 2300 into the front flap 1914. A part 2306 of the outer edge 2302 of the spout portion 2300 forms a part of an edge of the aperture enlargement portion 2304. Furthermore, part 2308 of the outer edge of the aperture enlargement portion 2304 is formed by a cutline or a frangible connection between the aperture enlargement portion 2304 and the front flap 1914. In the exemplary arrangement shown, a Further, part 2310 of the outer edge of aperture enlargement portion 2304 is foldably connected to the front flap 1914 by, for example, a fold line or other foldable connection.

The cutline forming the outer edge 2306 of the spout portion 2300 may be interrupted to form a connecting portion 2312 between the spout portion 2300 and the aperture enlargement portion 2304. The connecting portion 2312 forms a physical link between the spout portion 2300 and the aperture enlargement portion 2304. The connecting portion 2312 restricts the movement of the aperture enlargement portion 2304 about the foldable connection 2310, independent of the spout portion 2300.

In the arrangement of FIG. 23, the connecting portion 2312 holds the spout portion 2300 in alignment with the aperture enlargement portion 2304. This prevents snagging of either of these features when stacking cups.

The connecting portion 2312 may be configured to break under a force applied by a user when folding over the front flap 1914 to form the lid. In such arrangements, the spout portion 2300 remains in position and forms a spout, as described above.

The connecting portion 2312 may be configured to withstand the force applied by a user when folding over the front flap 1914 to form the lid. In such arrangements, the spout portion 2300 folds over with the front flap 1914, providing a closed lid. To assist this action, a fold line 2314 may be positioned at the bottom of the spout portion 2300, where it meets the rim 1906, although this feature is not essential.

The spout portion 2300 may be lifted by a user inserting a fingernail through the cutline 2306 and lifting the spout portion 2300, breaking the connecting portion. The aperture enlargement portion 2304 may be pushed through on application of a force in an inward direction by a user to form an enlarged aperture, for example, by pushing a straw into the aperture enlargement portion 2104 when the lid arrangement 1908 is closed. This may be done after lifting the spout portion 2300, or before.

A breaking strain of the connecting portion 2312 may be determined by a thickness of the interruption of the cutline 2306, or a thickness of the connecting portion 2312.

It will be appreciated that there are numerous embodiments of the spout portion 2100, 2300 and the aperture enlargement portion 2304.

For example, the spout portion may be formed by a single spout cutline extending from the rim 1906 into the front flap 1914. The aperture enlargement portion may be formed by two enlargement cutlines, each extending from the spout cutline. Distal ends of the enlargement cutlines may be connected by a foldable part of the front flap 1914.

In some examples, the single spout cutline may be interrupted by a connecting portion such that the spout portion and the aperture enlargement portion are connected, restricting independent movement of each. The connecting portion may be breakable under the force applied when folding the front flap 1914 to form the lid of the cup. Alternatively, the connecting portion may be arranged to withstand the force applied when folding the front flap 1914 to form the lid of the cup. In such arrangements, the spout portion may fold over with the front flap 1914.

In other arrangements, the spout portion may be connected to the aperture enlargement portion by a frangible connection across a part of the outer edge of the spout portion that also forms a part of an edge of the aperture enlargement portion.

In other arrangements, the spout cutline may be replaced with a frangible connection, and the two enlargement cutlines may be replaced with frangible connections.

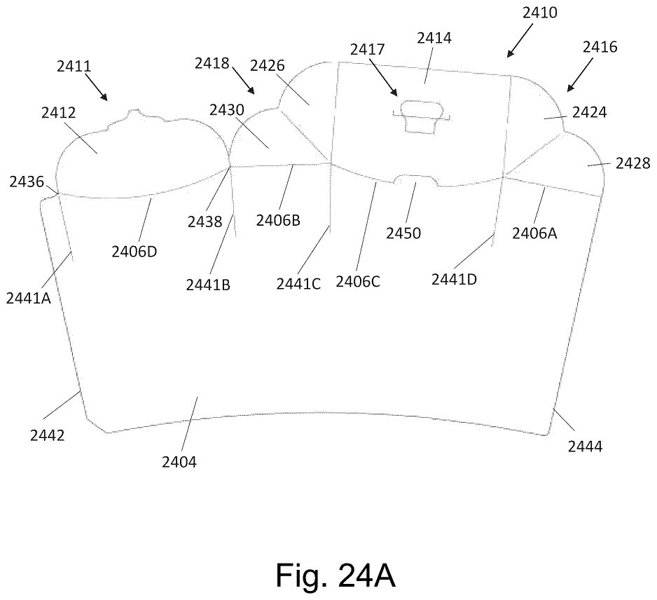

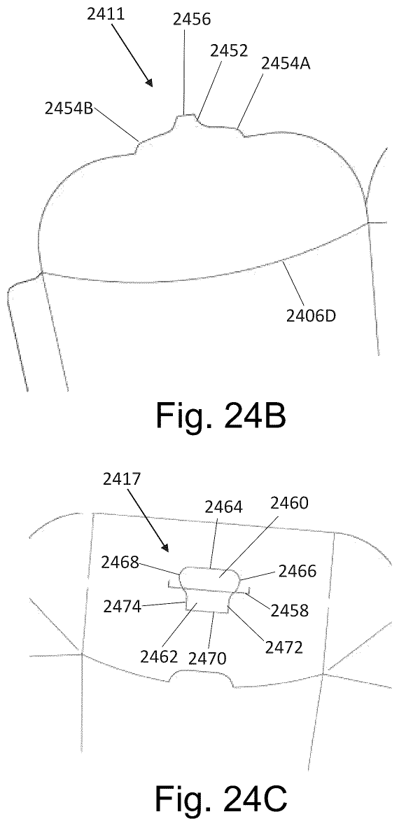

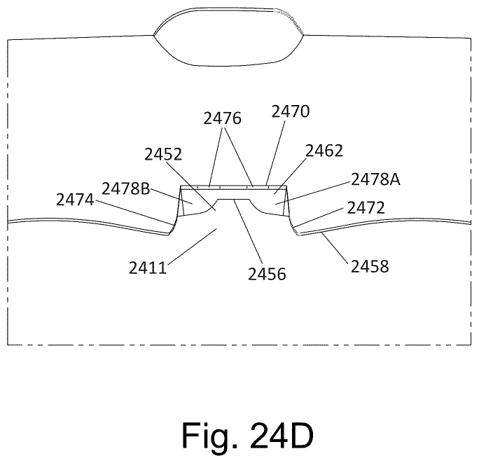

FIG. 24A shows an exemplary blank for forming a cup. Some of the features of the blank may be the same as those of the blank of FIGS. 20 and 21, and some of those features are not discussed below. In exemplary arrangements, the blank may not include the aperture enlargement portion 2104, as shown in FIG. 24A.

A lid arrangement comprises two flaps: a first closure flap 2410 and a second (rear) closure flap 2412. The first closure flap 2410 and the second closure flap 2412 extend vertically from the rim, generally in a direction continuing from a direction in which the wall 2404 extends from the base. The first closure flap 2410 extends around three sides of the generally rectangular rim. In the example shown in FIG. 24A, the first closure flap 2410 extends around a front side and the two lateral sides of the rim.

The first closure flap 2410 includes a front flap 2414 and two side flaps 2416, 2418. The front flap 2414 is foldable relative to the wall 2404 about a fold line 2406C, which forms the front side of the rim. The side flaps 2416, 2418 are adjacent to the front flap 2414 and opposite each other. The side flaps 2416, 2418 are foldable relative to the wall 2404 about fold lines 2406A and 2406B, which form lateral sides of the rim. The front flap 2414 extends along an arced side of the generally rectangular rim. The second closure flap 2412 is foldable relative to the wall 2404 about a fold line 2406D that forms the rear side of the rim and is opposite the front flap 2414 when the cup is formed. The rear fold line 2406D and/or the front fold line 2406C may be arced.

Each of the flaps of the lid arrangement 2408 is foldable along a fold line coincident with a corresponding portion of the rim. In addition, each of the side flaps 2416, 2418 is foldably connected to the front flap along vertical fold lines. Further, each side flap 2416, 2418 comprises a front portion 2424, 2426 and a rear portion 2428, 2430. The front portions 2424, 2426 are connected to the front flap 2414 at the vertical fold lines. The rear portions 2428, 2430 are connected to the wall 2404 at the lateral fold lines 2406A, 2406B. The front portions 2424, 2426 and rear portions 2428, 2430 of each side flap 2416, 2418 are foldably connected along oblique fold lines.

When the cup is formed, the rear flap 2412 is adjacent to the rear portions 2428, 2430 of the side flaps 2416, 2418 at two corners 2436, 2438 of the generally rectangular rim. The rear flap 2412 is not connected to the side flaps 2416, 2418. Notches are formed at the corners 2436, 2438, where the rear flap 2412 and the rear portions 2428, 2430 of the side flaps 2416, 2418 extend downwards to the rim. The rear flap 2412 is foldable independently of the side flaps 2416, 2418.

A side seam is formed on the wall 2404 of the cup when formed. The seam is a result of creating the cup from a blank. The blank is wrapped around so that an edge 2442 meets an edge 2444, thereby creating the seam when the edges are joined. It will be seen that the edge 2442 extends further than is necessary so as to form a flap that overlaps and is adhered to a corresponding portion of the wall 2404 at the edge 2444.

The seam runs from a corner 2436 of the rim where the rear flap 2412 is adjacent to one of the side flaps 2416, 2418. As a result, the seam stops at the rim and does not extend into any of the flaps of the lid arrangement. Accordingly, the seam does not interfere with the closing of the lid arrangement.

The wall 2404 also includes rim forming fold lines 2441A-D. These help create the substantially rectangular rim by encouraging the corners to be formed as the blank is folded around onto itself and formed into the cup.

The front flap 2414 includes a spout portion 2450. The spout portion 2450 is configured to remain in position when the remainder of the front flap 2414 is folded inwards when closing the lid arrangement. That is, the spout portion 2450 remains in a position extending from the rim in a direction aligned with the wall 2404 when the front flap 2414 is folded inwards.

The front flap 2414 is connected to the wall 2404 along the front fold line 2406C that forms an arced front side of the generally rectangular rim. The fold line 2406C is interrupted at the spout portion 2450. The fold line 2406C stops and is interrupted at the spout portion 2450. The spout portion 2450 is a continuous extension of the wall 2404. The spout portion 2450 is not joined to the wall 2404 by a fold line. An outer edge of the spout portion 2450 extends into the front flap 2414 and comprises a cut line or an otherwise frangible connection configured to break under a force applied to the front flap 2414 when folding it inwards. Therefore, as the front flap 2414 folds, the spout portion 2450 remains in position. This leaves an aperture in the front flap 2414 where the spout portion 2450 was previously, and forms an extended spout to aid drinking.

It is noted that other spout arrangements disclosed herein may be used with the blank (and resulting cup) shown in FIG. 24A.

In the exemplary arrangement of FIG. 24A, a tongue 2411 and/or a slit arrangement 2417 are configured such that when the tongue 2411 is engaged within the slit arrangement 2417, vent apertures are created in the lid. The vent apertures may advantageously allow air from within the cup to escape to the outside. This allows a user to smell the contents of the cup when drinking. In some arrangements, the vent apertures may be generally aligned with the nostrils of a user during drinking. That is, when the mouth of the user is covering the spout 2100 and the cup is tilted towards the user for drinking, the nostrils of the user may be substantially above the vent apertures.

FIG. 24B shows an enlarged view of the tongue 2411, which is formed on and extends from the rear flap 2412. The tongue 2411 comprises a neck 2452 and shoulders 2454A, 2454B on either side of the neck 2452. The neck 2452 extends beyond the shoulders 2454A, 2454B to form an elongate extension. In this example, a distal end 2456 of the neck is flattened, allowing it to but up against a surface. Optionally, the transition from the neck 2452 to each shoulder 2454A, 2454B forms a concave curve. This increases the rigidity of the neck 2454, especially when combined with the concave surface of the lid in a closed position formed by the rear flap 2412 as it is folded about the fold line 2406D. Optionally, each shoulder 2454 is formed by a convex curve extending down to the rear flap 2412.

As discussed below, the tongue 2411 interacts with the slit arrangement 2417 to form apertures in the lid. In arrangements, the tongue 2411 pushes a flap of the slit arrangement inwards for creating an aperture. The neck 2452 intersects the aperture to create vent apertures in the space on either side of the neck 2452. The shoulders 2454A, 2454B may be held underneath a slit such that they sit beneath the front flap 2414 and hold the tongue 2411 in a position to keep the flap of the slit arrangement 2417 pushed inwards.

FIG. 24C shows an enlarged view of the slit arrangement 2417 forming part of the front flap 2414. The slit arrangement 2417 comprises a lateral cut line 2458. On one side of the lateral cut line 2458 is a tongue receiving portion 2462 of the slit arrangement 2417. In some arrangements, on an opposite side of the lateral cut line 2458 is a rear flap receiving portion 2460 of the slit arrangement 2417.

The rear flap receiving portion 2460 forms a generally rectangular shape. A first edge of the generally rectangular shape of the rear flap receiving portion 2460 is formed by at least part of the lateral cut line 2458. A second edge 2464 of the generally rectangular shape of the rear flap receiving portion 2460 that is opposite to the first edge comprises at least one fold line. Third and fourth opposed edges 2466, 2468 of the generally rectangular shape of the rear flap receiving portion 2460 are formed by cut lines. The third and fourth opposed edges 2466, 2468 form convex curves.

The tongue receiving portion 2462 forms a generally rectangular shape. A first edge of the generally rectangular shape of the tongue receiving portion 2462 is formed by at least part of the lateral cut line 2458. A second edge 2470 of the generally rectangular shape of the tongue receiving portion 2462 that is opposite to the first edge comprises at least one fold line. Third and fourth opposed edges 2472, 2474 of the generally rectangular shape of the tongue receiving portion 2462 are formed by cut lines. At least part of the third and fourth opposed edges 2472, 2474 form concave curves for producing shoulder retaining edges that are configured to retain the shoulders 2454A, 2454B of the tongue 2411. A width of the tongue receiving portion 2462 is, in this example, less than a width of the rear flap receiving portion 2460.

In some exemplary arrangements, the fold line forming at least part of the second edge 2470 of the tongue receiving portion 2462 may cover less than the length of the second edge 2470. At least part of the second edge 2470 may be formed by one or more cut lines. For example, a cut line may form a portion of the second edge 2470 at the location where the flatted end 2456 of the neck 2452 engages with the tongue receiving portion 2462. Alternatively or in addition, further cut lines may form part of the second edge 2470. The tongue receiving portion 2462 forms a flap, foldable inwards about the second edge 2470.

The lateral cut line 2458 extends beyond a width of the rear flap receiving portion 2460 and/or the tongue receiving portion 2462. The lateral cut line 2458 includes portions to allow a portion of the front flap 2414 to be folded inwards.

FIG. 24D shows a top view of a cup with the lid arrangement in a closed position. The lid arrangement may be closed similarly to the method described with respect to FIGS. 22A-22F. When the user pushes downwards on the rear flap 2412, the neck 2452 pushes the tongue receiving portion 2462 inwards, which folds inwards about the second edge 2470. In the exemplary arrangement of FIG. 24D, the second edge 2470 comprises two fold lines 2476 and three cut lines. The fold lines 2476 are positioned on either side of the flattened end 2456 of the neck 2452.

The shoulders 2454A, 2454B are received and retained beneath the shoulder retaining edges formed by the concave curved regions of the third and fourth edges 2472, 2474 of the tongue receiving portion 2462. The pushing down of the rear flap 2412 by the user will allow the shoulders 2454A, 2454B to deform and snap under the third and fourth edges 2472, 2474, where they are retained.

Because the shoulders 2454A, 2454B are retained under the third and fourth edges 2472, 2474 of the tongue receiving portion 2462, the neck 2452 is held at a position lower than the surface of the lid. The flattened end 2456 of the neck 2452 therefore abuts against the tongue receiving portion 2452, which is thereby retained in the inwardly folded position.

This creates vent apertures 2478A, 2478B. The features of the lid arrangement may be dimensioned such that the vent apertures are aligned with the nostrils of a user when drinking.

It will be appreciated that the features described above may be applied to other cups and/or lids of cups. For example, the features described above may be applied to a separately fitted cup lid, which may be a plastic cup lid. Accordingly, a lid arrangement of a cup may comprise a foldable flap. The foldable flap may form part of a lid closure arrangement, similar to those discussed above, or may be a liftable flap forming a part of a lid, e.g., a liftable flap to create a drinking aperture. The foldable flap may comprise a tongue extending therefrom. The tongue may comprise a neck and shoulders, as described above. The lid may Further, comprise a slit arrangement. The slit arrangement may comprise a lateral cut line and a tongue receiving portion. At least one edge of the tongue receiving portion may be formed by the lateral cut line. At least one edge of the tongue receiving portion may include a fold line and at least one Further, cut line to form an inwardly foldable flap. In use, the foldable flap may be lifted and folded over onto the lid such that the neck engages the tongue receiving portion, folding it inwards and creating a vent aperture. The shoulders are retained under edges of the tongue receiving portion (or by another retaining mechanism), holding the neck in place and holding open the vent aperture.

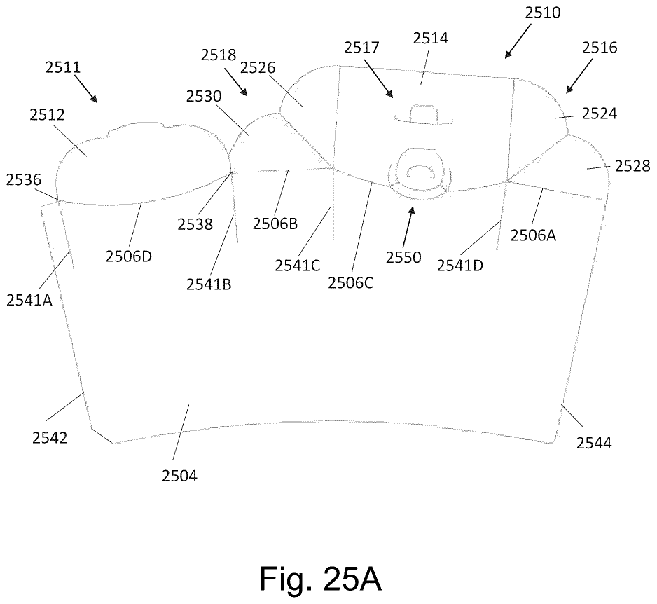

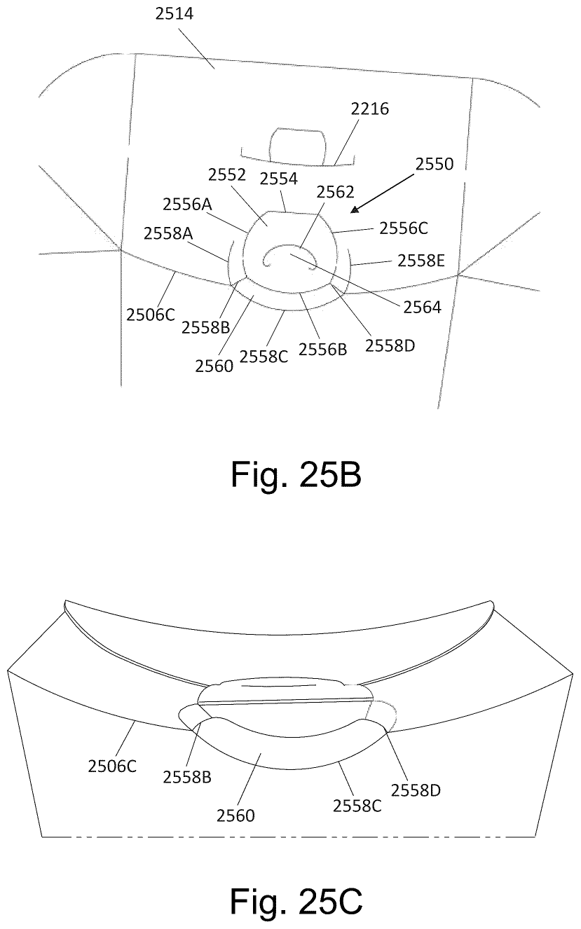

FIG. 25A shows an exemplary blank for making a cup. Some of the features of the blank may be the same as those of the blank of FIGS. 20 and 21. In exemplary arrangements, the spout of the blank of FIG. 25A may differ from those described above, and/or the blank may not include the aperture enlargement portion 2104, as shown in FIG. 25A.

A lid arrangement comprises two flaps: a first (front) closure flap 2510, and a second (rear) closure flap 2512. The first closure flap 2510 and the second closure flap 2512 extend vertically from the rim in a direction continuing from a direction in which the wall 2504 extends from the base. The first closure flap 2510 extends around three sides of the generally rectangular rim. In the example shown in FIG. 25A, the first closure flap 2510 extends around a front side and the two lateral sides of the rim.

The first closure flap 2510 includes a front flap 2514 and two side flaps 2516, 2518. The front flap 2514 is foldable relative to the wall 2504 about a fold line 2506C, which forms the front side of the rim. The side flaps 2516, 2518 are adjacent to the front flap 2514 and opposite each other. The side flaps 2516, 2518 are foldable relative to the wall 2504 about fold lines 2506A and 2506B, which form lateral sides of the rim. The front flap 2514 extends along an arced side of the generally rectangular rim. The second closure flap 2512 is foldable relative to the wall 2504 about a fold line 2506D that forms the rear side of the rim and is opposite the front flap 2514. The rear fold line 2506D may be arced.

Each of the flaps of the lid arrangement 2508 is foldable along a fold line coincident with a corresponding portion of the rim. In addition, each of the side flaps 2516, 2518 is foldably connected to the front flap along vertical fold lines. Further, each side flap 2516, 2518 is split into a front portion 2524, 2526 and a rear portion 2528, 2530. The front portions 2524, 2526 are connected to the front flap 2514 by the vertical fold lines. The rear portions 2528, 2530 are connected to the wall 2504 by the lateral fold lines 2506A, 2506B. The front portions 2524, 2526 and rear portions 2528, 2530 of each side flap 2516, 2518 are foldably connected along oblique fold lines.

The rear flap 2512 is adjacent to the rear portions 2528, 2530 of the side flaps 2516, 2518 at two corners 2536, 2538 of the generally rectangular rim. The rear flap 2512 is not connected to the side flaps 2516, 2518. Notches are formed at the corners 2536, 2538, where the rear flap 2512 and the rear portions 2528, 2530 of the side flaps 2516, 2518 extend downwards to the rim. The rear flap 2512 is foldable independently of the side flaps 2516, 2518.

A side seam is formed on the wall 2504 of the cup when formed. The seam is a result of creating the cup from a blank. The blank is wrapped around so that an edge 2542 meets an edge 2544, thereby creating the seam when the edges are joined. It will be seen that the edge 2542 extends further than is necessary so as to form a flap that overlaps and is adhered to a corresponding portion of the wall 2504 at the edge 2544.

The seam runs from a corner 2536 of the rim where the rear flap 2512 is adjacent to one of the side flaps 2516, 2518. As a result, the seam stops at the rim and does not extend into the lid arrangement. Accordingly, the seam does not interfere with the closing of the lid arrangement.

The wall 2504 also includes rim forming fold lines 2541A-D. These help create the substantially rectangular rim by encouraging the corners to be formed as the blank is formed into the cup.

The front flap 2514 includes a spout portion 2550, which is shown in greater detail in FIG. 25B.

In exemplary arrangements, the spout portion 2550 includes a liftable flap 2552. The liftable flap is connected to the front flap 2514 by a fold line 2554. The remaining edges of the liftable flap 2552 may be formed by cut lines 2556A-C such that the liftable flap 2552 is foldable inwards and/or outwards. One or more frangible connections (or perforations) between the liftable flap 2552 and the front flap 2514 may interrupt the cut lines 2556A-B to prevent unwanted movement of the liftable flap 2552 about the fold line 2554.

The cutline 2556B forms a convex curve. In exemplary arrangements, a part of the cut line 2556B may interrupt and extend below a fold line about which the front flap 2514 is folded, e.g., the front fold line 2506C. Accordingly, when the front flap 2514 is folded about the fold line, the liftable flap 2552 remains aligned with (and optionally connected to, via the frangible connections) the front flap 2514, and the cut line 2556B forms a lip protruding from the wall 2504 of the cup, allowing a user to gain purchase for lifting the liftable flap. It is noted that a convex curved cut line 2556B is not essential, and any other form of projection below the fold line may be used.

In the exemplary arrangement shown in FIGS. 25A and 25B, spout-forming fold lines 2558A-E are formed. Fold line 2558C forms a deviation of the fold line 2506C. That is, a deviation from the arc of the front fold line 2506C. In the example shown in FIGS. 25A and 25B, the deviation fold line forms a convex curve extending from the front fold line 2506C into the wall 2504. Oblique spout-forming fold lines 2558B and 2558D extend from the deviation fold line 2558C to the cut line 2556B of the liftable flap 2552. In the example shown in FIGS. 25A and 25B, the oblique fold lines extend from a junction of the front fold line 2506C and the deviation fold line 2558C. In the example shown in FIGS. 25A and 25B, the oblique fold lines meet the edge of the liftable flap 2552 at a junction between the cutlines 2556A and 2556B and at a junction between the cutlines 2556C and 2556B.

The fold line 2506C, the oblique spout forming fold lines 2558B and 2558D and the deviation fold line 2558C are configured such that the front flap 2514 folds about a line formed by the combination of the fold line 2506C, the oblique spout forming fold lines 2558B and 2558C and the cut line 2556B. As shown in FIG. 25C, this results in a spout region 2560 being formed that extends from the wall 2504 and stands proud of the surface of the lid. The spout region 2560 is the region between the deviation fold line and the cutline 2556B.

Spout-raising fold lines 2558A and 2558E extend from the front fold line 2506C into the front flap 2514. In the exemplary arrangement of FIGS. 25A-25C, the spout-raising fold lines 2558A and 2558E extend from the front fold line 2506C at the junctions between the front fold line 2506C and the deviation fold line 2558C. The spout-raising fold lines are angled inwards towards each other. As the front flap 2514 is folded about the line formed by the combination of the fold line 2506C, the oblique spout forming fold lines 2558B and 2558C, and the cut line 2556B, and the spout raising fold lines 2558A and 2558E cause the edges 2556A-C of the liftable flap 2552 to be raised to form a spout. In the example shown in FIGS. 25A and 25B, the spout-raising fold lines are curved inwards and angled towards the liftable flap 2552.

The arrangement described above results in the convex cutline 2556B forming a lip that does not leave an aperture in the sidewall 2504 of the formed cup, as can be seen in FIG. 25C. This helps prevent leaks.

A clasp cutline 2562 is formed on the liftable flap 2552. The clasp cutline is positioned such that when the liftable flap 2552 is folded onto the surface of the lid, a region of the liftable flap 2552 may be tucked under the slit 2216. The clasp cutline 2562 is curved such that a clasp portion 2564 of the liftable flap 2552 may be positioned against the slit 2216, allowing the remainder of the liftable flap 2552 to form a lever. Pushing the lever towards the surface of the lid tucks the clasp portion 2564 into the slit 2216 and under the front flap 2514. This holds the spout in an open position for drinking.

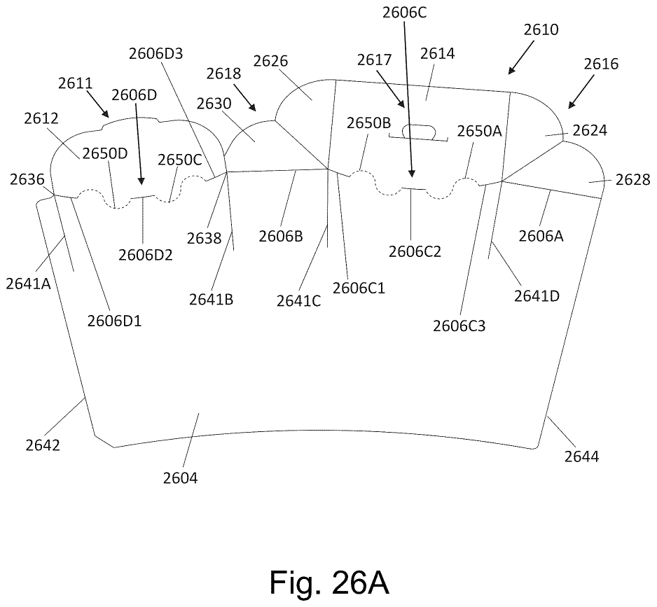

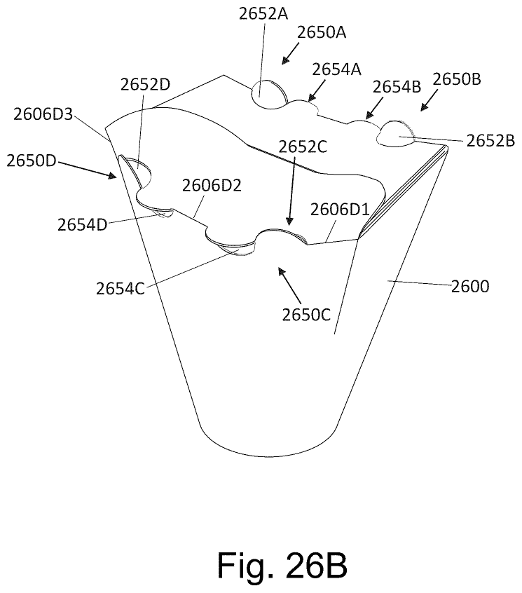

FIG. 26A shows an exemplary blank for forming a cup. Some of the features of the blank may be the same as those of the blank of FIGS. 20 and 21, and some of those features are not discussed again below. In exemplary arrangements, the blank may not include the aperture enlargement portion 2104 or the spout portion 2100, as in the blank shown in FIG. 26A. Accordingly, the blank shown in FIG. 26A may be suitable for containing food items.

A lid arrangement comprises two flaps: a first closure flap 2610, and a second (rear) closure flap 2612. The first closure flap 2610 and the second closure flap 2612 extend vertically from the rim, generally in a direction continuing from a direction in which the wall 2604 extends from the base. The first closure flap 2610 extends around three sides of the generally rectangular rim. In the example shown in FIG. 26A, the first closure flap 2610 extends around a front side and the two lateral sides of the rim.

The first closure flap 2610 includes a front flap 2614 and two side flaps 2616, 2618. The front flap 2614 is foldable relative to the wall 2604 about a fold line 2606C, which forms the front side of the rim. The side flaps 2616, 2618 are adjacent to the front flap 2614 and opposite each other. The side flaps 2616, 2618 are foldable relative to the wall 2604 about fold lines 2606A and 2606B, which form lateral sides of the rim. The front flap 2614 extends along an arced side of the generally rectangular rim. The second closure flap 2612 is foldable relative to the wall 2604 about a fold line 2606D that forms the rear side of the rim and is opposite the front flap 2614 when the cup is formed. The rear fold line 2606D and/or the front fold line 2606C may be arced.

Each of the flaps of the lid arrangement 2608 is foldable along a fold line coincident with a corresponding portion of the rim. In addition, each of the side flaps 2616, 2618 is foldably connected to the front flap along vertical fold lines. Further, each side flap 2616, 2618 comprises a front portion 2624, 2626 and a rear portion 2628, 2630. The front portions 2624, 2626 are connected to the front flap 2614 at the vertical fold lines. The rear portions 2628, 2630 are connected to the wall 2604 at the lateral fold lines 2606A, 2606B. The front portions 2624, 2626 and rear portions 2628, 2630 of each side flap 2616, 2618 are foldably connected along oblique fold lines.

When the cup is formed, the rear flap 2612 is adjacent to the rear portions 2628, 2630 of the side flaps 2616, 2618 at two corners 2636, 2638 of the generally rectangular rim. The rear flap 2612 is not connected to the side flaps 2616, 2618. Notches are formed at the corners 2636, 2638, where the rear flap 2612 and the rear portions 2628, 2630 of the side flaps 2616, 2618 extend downwards to the rim. The rear flap 2612 is foldable independently of the side flaps 2616, 2618.

A side seam is formed on the wall 2604 of the cup when formed. The seam is a result of creating the cup from a blank. The blank is wrapped around so that an edge 2642 meets an edge 2644, thereby creating the seam when the edges are joined. It will be seen that the edge 2642 extends further than is necessary so as to form a flap that overlaps and is adhered to a corresponding portion of the wall 2604 at the edge 2644.

The seam runs from a corner 2636 of the rim where the rear flap 2612 is adjacent to one of the side flaps 2616, 2618. As a result, the seam stops at the rim and does not extend into any of the flaps of the lid arrangement. Accordingly, the seam does not interfere with the closing of the lid arrangement.

The wall 2604 also includes rim-forming fold lines 2641A-D. These help create the substantially rectangular rim by encouraging the corners to be formed as the blank is folded around onto itself and formed into the cup.

The exemplary arrangement shown in FIG. 26A includes vent cut lines 2650A-D that interrupt the fold lines 2606C, 2606D. The vent cut lines 2650A, 2650B extend into the front flap 2614 above the fold line 2606C. The vent cut lines 2650A-D may extend into the respective closure flaps 2614, 2612, and/or into the wall 2604. For example, in FIG. 26A, the vent cut lines 2650A, 2650B extend into the front flap 2614 above the fold line 2606C, and into the wall 2604 below the fold line 2606C. The vent cut lines 2650C, 2650D extend into the rear flap 2612 above the fold line 2606D, and into the wall 2604 below the fold line 2606D.

Accordingly, one or more of the vent cut lines 2650A-D form lines that oscillate about a respective fold line 2606C, 2606D. That is, one or more vent cut lines 2650A-D may extend away from the respective fold line 2606C, 2606D into the respective closure flaps 2614, 2612, changes direction to cross the respective fold line 2606C, 2606D, extends into the wall 2604, and changes direction to return to the respective fold line 2606C, 2606D.

In the exemplary arrangement shown in FIG. 26A, the vent cut lines 2650A-D form an S-shape. However, the skilled person will understand that the vent cut lines 2650A-D may form a number of further shapes that oscillate about the respective fold line 2606C, 2606D, e.g., a sawtooth shape, square wave shape, a regular or irregular sinusoidal shape, as well as many other regular or irregular shapes.

In the exemplary arrangement shown in FIG. 26A, a distance the vent cut lines 2650A-D extend above the respective fold line 2606C, 2606D is the same as the distance the vent cut lines 2650A-D extend below the respective fold line 2606C, 2606D. However, the skilled person will appreciate that this need not be the case.

In the exemplary arrangement shown in FIG. 26A, a distance from a start of the vent cut lines 2650A-D to a crossover point of the vent cut lines 2650A-D is the same as a distance from the crossover point to an end of the vent cut lines 2650A-D. However, the skilled person will appreciate that this need not be the case.

Two vent cut lines 2650A-B are formed along the fold line 2606C. In the exemplary arrangement of FIG. 26A, the fold line 2606C comprises three sections 2606C1, 2606C2, 2606C3 and the vent cut lines 2650A, 2650B connect the three sections. The sections 2606C2, 2606D2 may be positioned centrally along a length of the fold line 2606C, 2606D. This provides additional stability to the front closure flap 2614, as explained below.

In exemplary arrangements, a similar structure may be used for the fold line 2606D, which comprises three sections 2606D1, 2606D2, 2606D3 connected by the two vent cut lines 2650C-D.

FIG. 26B shows a cup 2600 formed from the blank shown in FIG. 26A. In the view of the cup shown in FIG. 26B, the lid arrangement is in the closed position, which may be achieved using a process similar to that described above in respect of FIGS. 22A-22E.

As can be seen in FIG. 26B, when the lid arrangement is closed, each vent cut line 2650A-D forms a lid vent 2652A-D and a wall vent 2654A-D. These vents allow steam to escape from the cup and thereby allow hot food to remain crisp, preventing it from becoming soggy.

Because the vent cut lines 2650A-D oscillate about their respective fold line 2606C, 2606D vents are formed in the lid and in the wall 2604. Accordingly, a greater area of vent may be provided without creating single large apertures in the lid or wall, thereby reducing rigidity in the cup 2600. In addition, not all of the vent area is in the lid, thereby reducing the risk of foreign objects entering the cup 2600.

Further, the three sections of the fold lines 2606C, 2606D increase rigidity of the lid. This is particularly true of the central sections 2606C2, 2606D2. The central sections 2606C2, 2606D2 are aligned with the tongue of the rear flap 2612 and the slit of the front flap 2614 (see FIGS. 22B and 22C). This arrangement means that when the rear flap 2612 is depressed during closing, such that the tongue is inserted into the slit, there is no downward movement of the rear flap 2612 or the front flap 2614 at the point where it meets the wall 2604. The central sections 2606C2, 2606D2 resist downward pressure applied by the user during closing.

Additional rigidity is provided because the vent cut lines 2650A-D oscillate about the respective fold line 2606C, 2606D. When the lid arrangement is folded closed, the oscillation of the vent cut lines 2650A-DS results in tabs that extend beyond the cup and are transverse to each other. For each vent cut line 2650A-D, a first tab extends upwards from the wall 2604, and a second tab extends laterally outward from the rear flap 2612 or the front flap 2614, respectively. The second tab extends over the wall vent 2654A-D that it has formed when the lid arrangement has been folded. Accordingly, downward force on the rear flap 2612 or the front flap 2614 (e.g., during closing of the lid arrangement) attempts to force the second tab into the wall vent 2654A-D. Because the wall vent 2654A-D narrows as it extends downwards into the wall 2604, such downward force on the rear flap 2612 or the front flap 2614 is resisted by the second tab, which cannot move into the narrowing wall vent 2654A-D. In a similar way, lateral force is resisted by the first tab.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application similarly.

It should be understood that alternative embodiments or embodiments may comprise any or all combinations of two or more of the parts, elements, or features illustrated, described, or referred to in this specification.

As used herein, the term ‘and/or’ means ‘and’ or ‘or’, or where the context allows both. As used herein, “(s)” following a noun means the plural and/or singular forms of the noun. In this specification, the term “cup” comprises cups or other receptacles or containers with an approximately circular or polygon base and a wall extending from the base and having a cylindrical shape or a polygon prism shape and forming a space to hold liquids and/or solids, e.g., food and/or drinks. Additionally, in this specification, the term “liquid” may include any fluid of any viscosity and may also be expanded to include solids such as a collection of fine or large particles, such as, but not limited to, sugar crystals, salt crystals, candy or spice pieces. Thus, in this specification, the term “liquid” can be considered to be any content, in fluid or solid form, that may be accessible or otherwise poured from the cup.

Also, it is noted that at least some embodiments may be described as a method (i.e., process) that is depicted as a flowchart, a flow diagram, a structure diagram, or a block diagram. Although a flowchart may describe the operations as a sequential method, many of the operations can be performed in parallel or concurrently. In addition, the order of the operations may be rearranged. A method (i.e., process) is terminated when its operations are completed.

In this specification, the word “comprising” and its variations, such as “comprises”, has its usual meaning in accordance with International patent practice. That is, the word does not preclude additional or unrecited elements, substances, or method steps, in addition to those specifically recited. Thus, the described apparatus, substance, or method may have other elements, substances, or steps in various embodiments. The term “comprising” (and its grammatical variations) as used herein are used in the inclusive sense of “having” or “including” and not in the sense of “consisting only of”.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially,” as used herein, represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

The disclosure as described herein may also be said broadly to consist in the parts, elements and features referred to or indicated in the specification of the application, individually or collectively, and any or all combinations of any two or more said parts, elements or features, and where specific integers are mentioned herein, which have known equivalents in the art to which this invention relates, such known equivalents are deemed to be incorporated herein as if individually set forth.

It will be apparent to those skilled in the art that various modifications and variations can be made to the disclosed systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

The description of any of these alternative embodiments is considered exemplary. Any of the alternative embodiments and features in the alternative embodiments can be used in combination with each other or with the embodiments described with respect to the figures.

The foregoing describes only one or more embodiments of the present disclosure, and it is understood that modifications, obvious to those skilled in the art, may be made thereto without departing from the scope of the present invention. While the invention has been described with reference to a number of embodiments it should be appreciated that the invention can be embodied in many other forms.

1. A cup comprising:
a base;
a wall extending from the base to a rim of the cup; and
a lid arrangement including at least one closure flap extending from the rim and foldable inwards about a fold line coincident with at least part of the rim, to form at least part of a lid of the cup,
wherein the rim comprises a generally rectangular shape with at least one straight side and at least one arced side.

2. The cup according to claim 1, wherein the at least one closure flap defines at least part of an upper surface of the lid of the cup when folded inwards about the fold line, and wherein the upper surface has a concave curvature.

3. The cup according to claim 1, wherein the generally rectangular shape includes two straight sides and two arced sides.

4. The cup according to claim 1, wherein the at least one closure flap includes a plurality of closure flaps, and wherein a first closure flap and a second closure flap are separate from each other.

5. The cup according to claim 4, wherein the plurality of closure flaps are foldable about fold lines coincident with sides of the generally rectangular shaped rim,
wherein the first closure flap is foldable about a first arced fold line coincident with a first arced side,
and wherein the second closure flap is foldable about a second arced fold line coincident with a second arced side.

6. The cup according to claim 5, wherein the first closure flap comprises a locking opening,
and wherein the second closure flap comprises a locking tab receivable within the locking opening when the first and second closure flaps are folded inwards.

7. The cup according to claim 4, wherein the plurality of closure flaps comprise a first side flap foldable about a first straight fold line coincident with a first straight side of the generally rectangular shaped rim,
and a second side flap foldable about a second straight fold line coincident with a second straight side of the generally rectangular shaped rim.

8. The cup according to claim 1, wherein the at least one arced side of the generally rectangular shaped rim is arced outwards.

9. The cup according to claim 1, wherein a first closure flap comprises a foldable cover, moveable between an open position and a closed position and connected to the first closure flap by a cover fold line.

10. The cup according to claim 1, wherein a first closure flap comprises a spout portion including a foldable flap at least partially covering an aperture in the first closure flap and foldable inwards and/or outwards.

11. The cup according to claim 10, wherein an outer edge of the spout portion includes a cut line in the first closure flap.

12. The cup according to claim 11, Further, comprising a frangible connection between the spout portion and the first closure flap.

13. The cup according to claim 10, wherein the spout portion extends from the rim of the cup into the first closure flap.

14. The cup according to claim 10, wherein the spout portion interrupts the fold line about which the first closure flap is folded.

15. A cup comprising:
a base;
a wall extending from the base to a rim of the cup; and
a lid arrangement including at least one closure flap extending from the rim and foldable inwards about at least one lid fold line coincident with at least part of the rim, to form at least part of a lid of the cup,
wherein the rim comprises a generally rectangular shape, and the at least one closure flap includes a spout portion comprising a flap foldable inwards and/or outwards and connected to the closure flap by a cover fold line.

16. The cup according to claim 15, wherein an edge of the flap is formed by one or more cut lines in the at least one closure flap.

17. The cup according to claim 16, wherein the one or more cut lines extend into the at least one closure flap from the rim.

18. The cup according to claim 15, Further, comprising perforations between the foldable flap and the at least one closure flap.

19. The cup according to claim 15, wherein the lid arrangement comprises a plurality of closure flaps foldable inwards about a plurality of lid fold lines,
wherein the rim has a squashed rectangular shape,
and wherein sides of the generally rectangular rim are formed by the plurality of lid fold lines.

20. The cup according to claim 15, comprising a first closure flap and a second closure flap, the first closure flap being independently moveable with respect to the second closure flap.

21. A cup comprising:
a base;
a wall extending from the base to a rim of the cup; and
a lid arrangement including a first closure flap and a second closure flap, separate from the first closure flap,
wherein the rim comprises at least one straight side and at least two arced sides
wherein the first closure flap is foldable inwards about a first arced fold line coincident with a first arced side of the rim, and the second closure flap is foldable inwards about a second arced fold line coincident with a second arced side of the rim,
wherein, when folded inwards the first and second closure flaps form at least part of an upper surface a lid of the cup and define thereof,
and wherein the upper surface has a concave shape.
